(19) United States
(12) Patent Application Publication
(10) Pub. No.: US 2026/0051971 A1
(43) Pub. Date: Feb. 19, 2026

(54) APPARATUSES AND METHODS FOR POLAR CODING WITH RETRANSMISSIONS USING CROSS-BLOCK CHECK BLOCKS

(71) Applicant: Huawei Technologies Co., Ltd., Shenzhen (CN)

(72) Inventors: Van Hung Vu, Gatineau (CA); Yu Cao, Kanata (CA); Huazi Zhang, Hangzhou (CN)

(21) Appl. No.: 19/288,773

(22) Filed: Aug. 1, 2025

Related U.S. Application Data
(63) Continuation of application No. PCT/CN2023/074377, filed on Feb. 3, 2023.

(51) Int. Cl. H04L 1/00

(52) U.S. Cl. CPC H04L 1/0041; H04L 1/0045; H04L 1/0057; H04L 1/0071

(57) ABSTRACT

Methods and apparatuses for performing a set of transmissions using polar coding with retransmissions using cross-block check blocks are described. A first transmission is performed at a first code rate, the first transmission including a first plurality of information blocks, each information block having a plurality of information bits. A second transmission is performed at a second code rate that is lower than the first code rate. The second transmission includes a set of cross-block check blocks generated using information bits selected from across a second plurality of information blocks. Each of the second plurality of information blocks is a subset of the information bits of a respective one of the first plurality of information blocks, the information bits of each subset being selected from least reliable bit channels of the respective one of the plurality of information blocks.

### CROSS-REFERENCE TO RELATED APPLICATION

This application is a continuation of International Application No. PCT/CN2023/074377, entitled “APPARATUSES AND METHODS FOR POLAR CODING WITH RETRANSMISSIONS USING CROSS-BLOCK CHECK BLOCKS” and filed on Feb. 3, 2023, the disclosure of which is hereby incorporated by reference in its entirety.

### TECHNICAL FIELD

The present disclosure relates to methods and apparatuses for wireless communications using polar coding with retransmissions, including retransmission schemes using cross-block check blocks.

### BACKGROUND

In many applications in wireless communications, it is useful for the transmitter to use a rate compatible code. Generally, a rate compatible code provides flexibility to enable the transmitter to adapt the code rate to be supportable by the capacity of the wireless communication channel. This is particularly useful in cases where the quality of the channel is unknown at the transmitter and/or the quality of the channel is quickly varying.

Polar codes have been of interest in 5th generation (5G) wireless communications and are of interest for future generation wireless communications. Polar codes are relatively low in complexity and can be adapted to achieve channel capacity in a wide range of channels. However, because channel capacity may not be fully known at the transmitter and/or may change quickly, a retransmission scheme is needed.

Accordingly, it would be useful to provide solutions for performing transmissions using polar coding with a retransmission scheme.

### SUMMARY

In various examples, the present disclosure describes methods and apparatuses for wireless communications using polar coding, in which cross-block check blocks are used for retransmissions with incremental freezing.

Examples of the present disclosure may provide more efficient rate-compatible polar coding for large packet transmissions in multicast, groupcast or broadcast applications, as well as hybrid automatic repeat request (HARQ) and network coding applications.

In a first transmission (also referred to as an initial transmission), a packet (or transport block) having multiple code blocks is transmitted using polar code. If the initial transmission fails (i.e., cannot be successfully decoded by the receiver node), the transmitter node generates cross-block check blocks by selecting information bits from the least reliable bit channels of the information blocks of the initial transmission. The cross-block check blocks are transmitted in a subsequent transmission (also referred to as a retransmission).

Examples of the present disclosure may provide a technical advantage in that feedback overhead may be reduced. Another technical advantage is the disclosed retransmission scheme may enable the receiver node to use successive decoding to help reduce the decoding complexity compared to some existing decoding schemes.

Examples of the present disclosure may enable a set of transmission (i.e., initial transmission and one or more retransmissions) to be performed using a predefined set of code rates, or using arbitrary or dynamically determined code rates (e.g., dynamically determined by the transmitter node for each transmission, based on feedback from the receiver node).

In an example aspect, the present disclosure describes a method at a transmitter node, the method including: performing a first transmission at a first code rate, the first transmission including a first plurality of information blocks, each information block having a plurality of information bits; and performing a second transmission at a second code rate, the second code rate being lower than the first code rate, the second transmission including a set of cross-block check blocks generated using information bits selected from across a second plurality of information blocks, each of the second plurality of information blocks being a subset of the information bits of a respective one of the first plurality of information blocks, the information bits of each subset being selected from least reliable bit channels of the respective one of the plurality of information blocks.

In an example of the preceding example aspect of the method, the second code rate is a predefined fraction of the first code rate.

In an example of a preceding example aspect of the method, the method may include: prior to performing the second transmission, receiving information indicative of a code rate for a next transmission; and selecting the second code rate based on the received information.

In an example of the preceding example aspect of the method, the first transmission and the second transmission are intended for one or more receiver nodes, and the information may be received as feedback from at least one of the one or more receiver nodes.

In an example of the preceding example aspect of the method, the information may be received as an index value that maps to a fraction value representing an amount of successful decoding decisions by the at least one receiver node over a set of frozen bits.

In an example of some of the preceding example aspects of the method, the method may include: prior to performing the second transmission, transmitting control information to the one or more receiver nodes, the control information indicating the selected second code rate.

In an example of any of the preceding example aspects of the method, each information block of the second plurality of information blocks may be sized such that a size of a remaining subset of unselected information bits of the respective one of the first plurality of information blocks corresponds to an effective code rate equal to the second code rate.

In an example of any of the preceding example aspects of the method, at least two information blocks of the first plurality of information blocks may be of dissimilar size.

In an example of the preceding example aspect of the method, at least two information blocks of the second plurality of information blocks that correspond to subsets of the respective at least two information blocks of the first plurality of information blocks may also be of dissimilar size.

In an example of the preceding example aspect of the method, the at least two information blocks of the second plurality of information blocks may be sized at a given proportion relative to each other, and each cross-block check block in the set of cross-block check blocks may be generated by selecting information bits across the at least two information blocks according to the given proportion.

In an example of any of the preceding example aspects of the method, the set of cross-block check blocks may be generated by cross-interleaving the information bits selected from across the second plurality of information blocks.

In an example of any of the preceding example aspects of the method, the first transmission and the second transmission may belong to a set of transmissions for transmitting the first plurality of information blocks, and the method may include: performing at least one further transmission in the set of transmissions, wherein the at least one further transmission is at a code rate that is lower than code rates of all prior transmissions in the set of transmissions, and wherein the further transmission includes a further set of cross-block check blocks generated using information bits selected from across a further plurality of information blocks, the further plurality of information blocks being subsets of the information bits of the plurality of information blocks of each prior transmission, the subsets being selected from least reliable bit channels that have not been included in previously selected subsets.

In an example of the preceding example aspect of the method, one or more further transmissions may be performed until a predefined number of transmissions for the set of transmissions has been reached.

In another example aspect, the present disclosure describes a method at a receiver node, the method including: receiving, from a transmitter node, a first transmission at a first code rate, the first transmission including a first plurality of information blocks, each information block having a plurality of information bits; performing a decoding operation to decode the first plurality of information blocks, the decoding being unsuccessful; receiving, from the transmitter node, a second transmission at a second code rate that is lower than the first code rate, the second transmission including a set of cross-block check blocks generated using information bits selected from across a second plurality of information blocks, each of the second plurality of information blocks being a subset of the information bits of a respective one of the first plurality of information blocks, the information bits of each subset being selected from least reliable bit channels of the respective one of the plurality of information blocks; and performing another decoding operation to decode the set of cross-block check blocks, wherein the decoded set of cross-block check blocks is useable to assist in decoding the first plurality of information blocks.

In an example of the preceding example aspect of the method, the set of cross-block check blocks may be successfully decoded, and the method may include: recovering the second plurality of information blocks from the decoded set of cross-block check blocks; and passing information bits of the recovered second plurality of information blocks to be used as frozen bits to assist in decoding the first plurality of information blocks.

In an example of any of the preceding example aspects of the method, the method may include: prior to receiving the second transmission, transmitting feedback to the transmitter node, the feedback including information indicative of an amount of frozen bits correctly determined by the receiver node for the first transmission.

In an example of the preceding example aspect of the method, the fed back information may be an index value that maps to a fraction value representing an amount of successful decoding decisions by the receiver node over a set of frozen bits.

In an example of any of the preceding example aspects of the method, the method may include: prior to receiving the second transmission, receiving control information from the transmitter node, the control information indicating the second code rate.

In another example aspect, the present disclosure describes an apparatus including a processing unit configured to cause the apparatus to perform the method of any one of the preceding example aspects of the method.

In another example aspect, the present disclosure describes a non-transitory computer readable medium having machine-executable instructions stored thereon, where the instructions, when executed by a processing unit of an apparatus, cause the apparatus to perform the method of any one of the preceding example aspects of the method.

In another example aspect, the present disclosure describes a computer program product comprising instructions which, when the program is executed by a computer, cause the computer to perform the method of any one of the preceding example aspects of the method.

### BRIEF DESCRIPTION OF THE DRAWINGS

Reference will now be made, by way of example, to the accompanying drawings which show example embodiments of the present application, and in which:

FIG. 1 illustrates an example wireless communication system, in which examples of the present disclosure may be implemented;

FIG. 2 illustrates an example apparatus that may be used to implement examples of the present disclosure;

FIGS. 3A and 3B illustrate an example of a set of transmissions performed by a transmitter node, using predefined code rates, in accordance with examples of the present disclosure;

FIG. 3C illustrates an example of successive decoding a receiver node, in accordance with examples of the present disclosure;

FIGS. 4A and 4B illustrate examples of a set of transmissions performed by a transmitter node, using arbitrary code rates for the transmissions, in accordance with examples of the present disclosure;

FIG. 5 illustrates an example of a set of transmissions performed by a transmitter node, in which the information blocks are dissimilar in size, in accordance with examples of the present disclosure;

FIGS. 6A and 6B are signaling diagrams illustrating example communications between a transmitter node and one or more receiver nodes, in accordance with examples of the present disclosure;

FIG. 7 is a flowchart of an example method at a transmitter node, in accordance with examples of the present disclosure; and

FIG. 8 is a flowchart of an example method at a receiver node, in accordance with examples of the present disclosure.

Similar reference numerals may have been used in different figures to denote similar components.

### DETAILED DESCRIPTION

To assist in understanding the present disclosure, an example wireless communication system is first described.

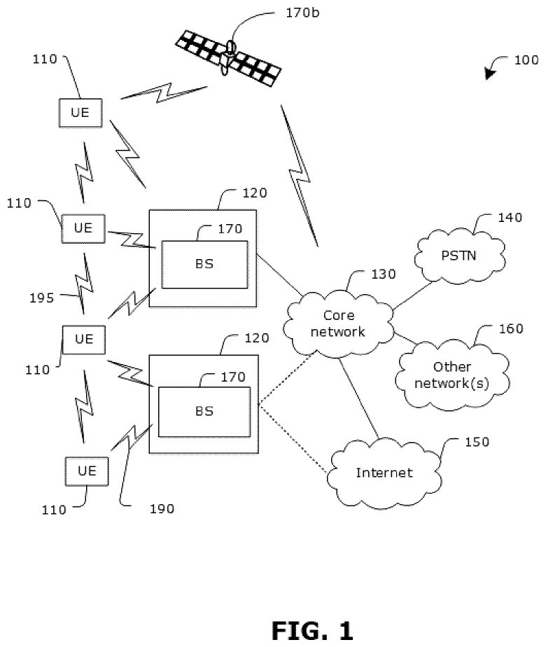

FIG. 1 illustrates an example wireless communication system 100 (also referred to as a wireless system 100) in which embodiments of the present disclosure could be implemented. In general, the wireless system 100 enables multiple wireless or wired elements to communicate data and other content. The wireless system 100 may enable content (e.g., voice, data, video, text, etc.) to be communicated (e.g., via broadcast, groupcast, multicast, narrowcast, device to device, etc.) among entities of the system 100. The wireless system 100 may operate by sharing resources such as bandwidth. The wireless system 100 may be suitable for wireless communications using 5G technology (e.g., 5G New Release (NR) and Long-Term Evolution (LTE) technologies) and/or later generation wireless technology. In some examples, the wireless system 100 may also accommodate some legacy wireless technology (e.g., 3G or 4G wireless technology).

In the example shown, the wireless system 100 includes user equipment (UEs) 110, radio access networks (RANs) 120, a core network 130, a public switched telephone network (PSTN) 140, the internet 150, and other networks 160. In some examples, one or more of the networks may be omitted or replaced by a different type of network. Other networks may be included in the wireless system 100. Although certain numbers of these components or elements are shown in FIG. 1, any reasonable number of these components or elements may be included in the wireless system 100.

The UEs 110 are configured to operate, communicate, or both, in the wireless system 100. For example, the UEs 110 may be configured to transmit, receive, or both via wireless or wired communication channels. The term “UE” may be used to refer to any suitable end user device for wireless operation and may include such devices (or may be referred to) as a wireless transmit/receive unit (WTRU), a mobile station, a mobile relay, a fixed or mobile subscriber unit, a cellular telephone, a station (STA), a machine type communication (MTC) device, a personal digital assistant (PDA), a smartphone, a laptop, a computer, a tablet, a wireless sensor, an internet of things (IoT) device, a network-enabled vehicle, or a consumer electronics device, among other possibilities. In some examples, the term electronic device (ED) may be used instead of UE. In general, it should be understood that the use of the term UE in the present disclosure does not necessarily limit the present disclosure to any specific wireless technology.

In FIG. 1, the RANs 120 include base stations (BSs) 170. Although FIG. 1 shows each RAN 120 including a single respective BS 170, it should be understood that any given RAN 120 may include more than one BS 170, and any given RAN 120 may also include base station controller(s) (BSC), radio network controller(s) (RNC), relay nodes, elements, and/or devices. FIG. 1 also depicts a non-terrestrial BS 170b, which may be part of a non-terrestrial network (not shown). A non-terrestrial BS 170b may also be referred to as a satellite. The non-terrestrial BS 170b may communicate with the core network 130 using satellite transmissions. A non-terrestrial BS 170b may wirelessly communicate with one or more UEs 110, similar to terrestrial BSs 170. Communications between a non-terrestrial BS 170b and a UE 110 (which is typically a terrestrial entity) may be slower compared to communications between a terrestrial BS 170 and a UE 110, due to the longer distance between a non-terrestrial BS 170b and a UE 110. For simplicity, a non-terrestrial BS 170b may be referred to as simply a BS 170, except where explicitly stated.

Each BS 170 is configured to wirelessly interface with one or more of the UEs 110 to enable access to any other BS 170, the core network 130, the PSTN 140, the internet 150, and/or the other networks 160. For example, the BSs 170 may also be referred to as (or include) a base transceiver station (BTS), a radio base station, a Node-B (NodeB), an evolved NodeB (eNodeB or eNB), a Home eNodeB, a gNodeB (gNB) (sometimes called a next-generation Node B), a transmission point (TP), a transmission and reception point (TRP), a site controller, an access point (AP), or a wireless router, among other possibilities. Future generation BSs 170 may be referred to using other terms. In some examples, the term TRP may be used to encompass a BS 170 or any other node that may serve to transmit and receive communications. Thus, although the present disclosure makes references to BSs 170, it should be understood that this is not intended to be limiting. Any UE 110 may be alternatively or additionally configured to interface, access, or communicate with any other BS 170, the internet 150, the core network 130, the PSTN 140, the other networks 160, or any combination of the preceding. In some examples, a BS 170 may access the core network 130 via the internet 150.

The UEs 110 and BSs 170 are examples of communication equipment that can be used to implement some or all of the functionality and/or embodiments described herein. Any BS 170 may be a single element, as shown, or multiple elements, distributed in the corresponding RAN 120, or otherwise. Each BS 170 transmits and/or receives wireless signals within a particular geographic region or area, sometimes referred to as a “cell” or “coverage area”. A cell may be further divided into cell sectors, and a BS 170 may, for example, employ multiple transceivers to provide service to multiple sectors. In some embodiments there may be established pico or femto cells where the radio access technology supports such. A macro cell may encompass one or more smaller cells. The number of networks (including terrestrial networks and non-terrestrial networks) shown is exemplary only. Any number of networks may be contemplated when devising the wireless system 100.

The BSs 170 communicate with one or more of the UEs 110 over one or more uplink (UL)/downlink (DL) wireless interfaces 190 (e.g., via radio frequency (RF), microwave, infrared, etc.). The UL/DL interface 190 may also be referred to as a UL/DL connection, UE-BS link/connection/interface, or UE-network link/connection/interface, for example. The UEs 110 may also communicate directly with one another (i.e., without involving the BS 170) via one or more sidelink (SL) wireless interfaces 195. The SL interface 195 may also be referred to as a SL connection, UE-to-UE link/connection/interface, vehicle-to-vehicle (V2V) link/connection/interface, vehicle-to-everything (V2X) link/connection/interface, vehicle-to-infrastructure (V2I) link/connection/interface, vehicle-to-pedestrian (V2P) link/connection/interface, device-to-device (D2D) link/connection/interface, or simply as SL, for example. The wireless interfaces 190, 195 may utilize any suitable radio access technology. For example, the wireless system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) for wireless communications.

The RANs 120 are in communication with the core network 130 to provide the UEs 110 with various services such as voice, data, and other services. The RANs 120 and/or the core network 130 may be in direct or indirect communication with one or more other RANs (not shown), which may or may not be directly served by core network 130, and may or may not employ the same radio access technology. The core network 130 may also serve as a gateway access between (i) the RANs 120 or UEs 110 or both, and (ii) other networks (such as the PSTN 140, the internet 150, and the other networks 160). In addition, some or all of the UEs 110 may include functionality for communicating with different wireless networks over different wireless links using different wireless technologies and/or protocols. Instead of wireless communication (or in addition thereto), the UEs 110 may communicate via wired communication channels to a service provider or switch (not shown), and to the internet 150. PSTN 140 may include circuit switched telephone networks for providing plain old telephone service (POTS). The internet 150 may include a network of computers and subnets (intranets) or both, and incorporate protocols, such as Internet Protocol (IP), Transmission Control Protocol (TCP), User Datagram Protocol (UDP). The UEs 110 may be multimode devices capable of operation according to multiple radio access technologies, and incorporate multiple transceivers necessary to support such.

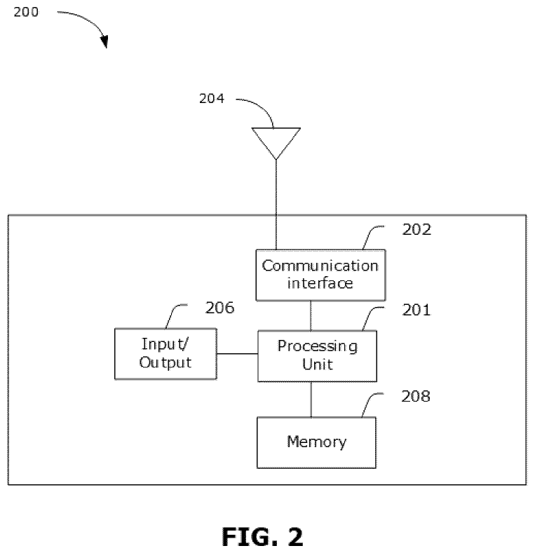

FIG. 2 illustrates an example apparatus 200 that may implement examples disclosed herein. FIG. 2 illustrates a possible embodiment for the UE 110 or the BS 170, and is not intended to be limiting.

As shown in FIG. 2, an example apparatus 200 (e.g., an example embodiment of the UE 110 or BS 170) includes at least one processing unit 201. The processing unit 201 implements various processing operations of the apparatus 200. For example, the processing unit 201 could perform signal coding, data processing, power control, input/output processing, or any other functionality of the apparatus 200. The processing unit 201 may also be configured to implement some or all of the functionality and/or embodiments described in more detail herein. Each processing unit 201 includes any suitable processing or computing device configured to perform one or more operations. Each processing unit 201 could, for example, include a microprocessor, microcontroller, digital signal processor, field programmable gate array, or application specific integrated circuit. Each of the at least one processing unit 201 may include one or more processor cores.

The apparatus 200 includes at least one communication interface 202 for wired and/or wireless communications. One or multiple communication interfaces 202 could be used in the apparatus 200. Each communication interface 202 includes any suitable structure for generating signals for wireless or wired transmission and/or processing signals received wirelessly or by wire. Although shown as a single functional unit, the communication interface 202 could also be implemented using at least one transmitter interface and at least one separate receiver interface. In some examples, one or more transmitters and one or more receivers may be implemented by the communication interface 202.

The apparatus 200 includes one or more antennas 204 for wireless communications. Each antenna 204 includes any suitable structure for transmitting and/or receiving wireless signals. In some examples, the apparatus 200 may include multiple antennas 204 to support multiple-input multiple-output (MIMO) communications. There may be multiple antennas 204 that together form an antenna array, which may be used for beamforming and beam steering operations. In some examples, there may be one or more antennas 204 used for transmitting signals and separate one or more antennas 204 used for receiving signals.

The apparatus 200 further includes one or more input/output devices 206 or input/output interfaces (such as a wired interface to the internet 150). The input/output device(s) 206 permit interaction with a user or other devices in the wireless system 100. Each input/output device 206 includes any suitable structure for providing information to or receiving information from a user, such as a speaker, microphone, keypad, keyboard, display, or touchscreen, including network interface communications.

In addition, the apparatus 200 includes at least one memory 208. The memory 208 stores instructions and data used, generated, or collected by the apparatus 200. For example, the memory 208 could store software instructions or modules configured to implement some or all of the functionality and/or embodiments described herein and that are executed by the processing unit(s) 201. Each memory 208 includes any suitable volatile and/or non-volatile storage and retrieval device(s). Any suitable type of non-transitory memory may be used, such as random access memory (RAM), read only memory (ROM), hard disk, optical disc, subscriber identity module (SIM) card, memory stick, secure digital (SD) memory card, and the like.

In wireless communication systems, a BS 170 may transmit data (e.g., a transport block (TB)) to one or more UEs 110. A TB can be segmented and encoded by forward error correction (FEC) codes to generate multiple code blocks (CBs) for transmission. Additionally, several CBs in TB can be grouped to form a code block group (CBG). An example of a FEC code that can be used to generate the CBs is a polar code. The polar code used to encode the CB can be a systematic or non-systematic code. If a systematic polar code is used, the CB includes both information bits (also referred to as systematic bits) and check bits (also referred to as parity bits) The information bits represent the data, while the check bits represent the redundancy bits calculated and added by the polar code for error correction. If a non-systematic polar code is used, the CB does not contain information bits (i.e., only check bits are included in the CB).

A transmitter node (e.g., a BS 170 for a DL transmission, or a UE 110 for an UL or SL transmission) may encode information bits into an encoded codeword using a polar encoder. The polar encoder receives an input vector that is N bits in length. The input vector carries data only in K information bits (where K<N) and the remaining bits of the input vector do not carry data. These bits that do not carry data are referred to as frozen bits, and there are (N−K) frozen bits in the input vector. The positions of the frozen bits in the input vector are known to both the transmitter node and the intended receiver node. Because the frozen bits do not carry data, the frozen bits can be set to any bit value. Typically, the frozen bits are all set to zero.

Each input bit (i.e., each bit of the input vector) to the polar encoder corresponds to a bit channel. A bit channel is a synthetic channel created by the polar encoder. These synthetic bit channels created by the polar encoder may also be known as subchannels. Each bit channel has a corresponding reliability that is calculated based on the physical channel from the transmitter node to the receiver node. The reliability of each bit channel is calculated or known in advance, with some bit channels having higher reliabilities (i.e., having higher probability to be successfully decoded at the receiver node) and some bit channels having lower reliabilities (i.e., having lower probability to be successfully decoded at the receiver node). The K information bits are mapped to K bit positions corresponding to the K bit channels having the highest reliabilities, and the remaining N−K bit positions are assigned to the frozen bits.

There has been interest in developing retransmission schemes for polar coding. Hybrid automatic repeat request (HARQ) is a commonly used retransmission technique. Conventional HARQ retransmission schemes are typically based on whether a TB was successfully decoded by a receiver node. If the receiver node was unsuccessful in decoding even one CB of a TB, then negative feedback is sent back to the transmitter node and the transmitter node performs a retransmission of the entire TB (e.g., a single TB may form a transmission packet) or a predefined group of CBs (referred to as a CB group (CBG)) containing the unsuccessfully decoded CB, even if other CBs of the TB or CBG were successfully decoded by the receiver node. This may be an inefficient use of communication resources. The inefficiency of conventional HARQ retransmission schemes may be exacerbated in broadcast, multicast or groupcast scenarios, in which different receiver nodes may have errors in decoding different CBs. A retransmission of a TB or CBG that contains a CB that was not successfully decoded by one receiver node may be redundant for another receiver node that did successfully decode all the CBs of the TB or CBG.

A HARQ scheme for polar coding has been proposed (see Li et al. “Capacity-achieving rateless polar codes,” 2016 IEEE Inter. Symp. on Info. Theory (ISIT), 2016; Hong et al. “Capacity-achieving rate-compatible polar codes,” IEEE Tran. on Info. Theory, vol. 63, no. 12, December 2017), based on the concept of incremental freezing. In incremental freezing, if the information bits are not successfully decoded in an initial transmission, subsets of information bits which are located in least reliable channels can be retransmitted. The code rate in such a retransmission is essentially lower than that of the previous transmission, so the information bits in the retransmission have a higher chance to be decoded successfully. If the information bits in a retransmission are decoded successfully, those successfully decoded bits can then be considered to be frozen bits for decoding the initial transmission. The result is that the effective code rate of the initial transmission is lowered, which may enable the rest of the information bits (which were not sent in the retransmission) to be decoded.

However, the incremental freezing scheme shares some of the drawbacks of conventional HARQ retransmission schemes. In an incremental freezing retransmission scheme, each retransmission contains a subset of the information bits of a previously transmitted CB. However, if the transmission is a broadcast, multicast or groupcast transmission, different receiver nodes may have error in decoding different CBs. At the same time, it is not possible to transmit different CBs to different receiver nodes in a broadcast, multicast or groupcast scenario. This means that there will be inefficiencies in the retransmissions because some receiver nodes will find the information in any given retransmission to be redundant. This problem is exacerbated if there are many receiver nodes and/or the transmission is a large packet transmission that contains many CBs, or in a network coding scenario. Another drawback of an incremental freezing retransmission scheme is that if a CB cannot be decoded in any transmission, the performance of the whole TB (which contains multiple CBs) is corrupted.

In various examples, the present disclosure describes a retransmission scheme for polar coding, in which cross-block check blocks are used for retransmission.

Retransmission schemes based on the use of cross-block check blocks (also referred to as cross-packet check blocks or vertical check blocks) have been described. For example, techniques for generating cross-block check blocks have been described in U.S. patent application Ser. No. 16/665,121, entitled “SYSTEM AND METHOD FOR HYBRID-ARQ”, filed Oct. 28, 2019, the entirety of which is hereby incorporated by reference. The use of cross-block check blocks in network coding (also referred to as 2D network coding or 2D joint network coding) has been described in U.S. patent application Ser. No. 17/110,226, entitled “METHODS AND SYSTEMS FOR NETWORK CODING USING CROSS-PACKET CHECK BLOCKS”, filed Dec. 2, 2020, the entirety of which is hereby incorporated by reference.

In general, a cross-block check block is formed by check bits that are generated from information bits selected from across two or more different CBs. A cross-block check block may be generated by, for example, selecting information bits from across two or more CBs, then encoding (e.g., using a FEC code, such as low-density parity-check (LDPC) code) or otherwise combining (e.g., using XOR, linear combination, etc.) the selected bits to obtain the cross-block check block. In some examples, a cross-block check block may be referred to as a “vertical” check block, to distinguish from a “horizontal” check block such as a conventional cyclic redundancy check (CRC) block that is generated using information bits of a single CB.

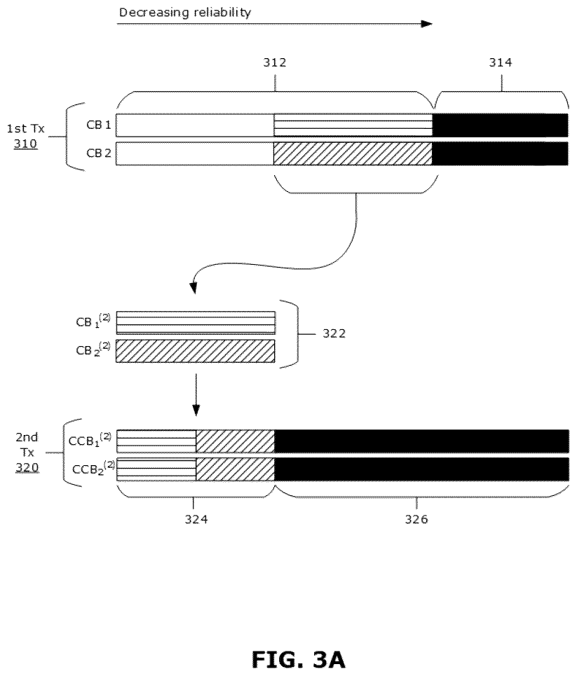

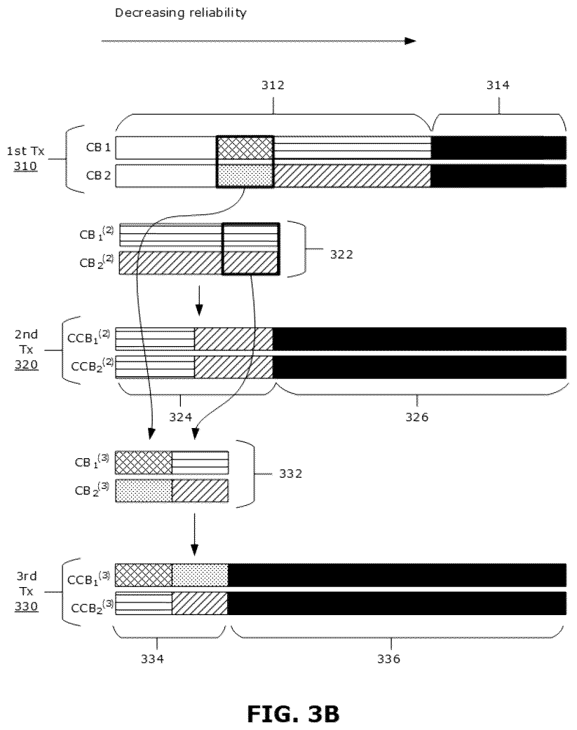

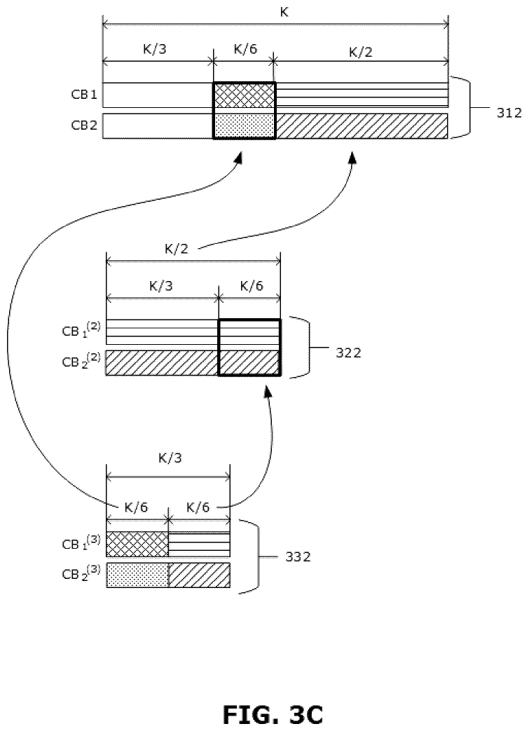

In the present disclosure, one or more cross-block check blocks are generated from a subset of the information bits of the CBs sent in a first transmission (also referred to as an initial transmission). The generated one or more cross-block check blocks are then used for performing a second transmission (which may also be referred to as a retransmission) that has a lower code rate than the code rate of the first transmission. Because each cross-block check block is generated using information bits selected from across the CBs of an initial transmission, the cross-block check block provides information for decoding a plurality of the CBs of the first transmission. Further, because the code rate of the second transmission is lower than that of the first transmission, there is a higher likelihood that the second transmission will be successfully decoded. Information bits that are successfully decoded from the second transmission can then be used as frozen bits to help in decoding the first transmission. Further details are discussed with respect to FIG. 3.

FIGS. 3A and 3B illustrate a simple example of a retransmission scheme for polar coding, as disclosed herein. The example may represent DL transmissions (e.g., where a BS 170 is the transmitter node and one or more UEs 110 are receiver nodes), UL transmissions (e.g., where a UE 110 is the transmitter node and a BS 170 is the receiver node), or SL transmissions (e.g., where a UE 110 is the transmitter node and one or more other UEs 110 are receiver nodes), without limitation.

In this simplified example, two CBs (namely CB1 and CB2) are transmitted by the transmitter node in a first transmission (denoted 1st Tx) 310. Although only two CBs are shown, it should be understood that there may be more than two CBs in the first transmission, and the number of CBs in the first transmission may be large in the case of a large packet transmission. In general, a plurality of CBs may be transmitted in the first transmission.

In this example, it is assumed that the first transmission and subsequent transmissions all use a similar resource to transmit data, and the codeword length (denoted N) of each transmitted block is similar. The first transmission has a first code rate (denoted R₁), and each subsequent transmission of the same information has a code rate that is lower than all previous transmissions. For example, if a second transmission has a code rate denoted R₂ and a third transmission has a code rate denoted R₃, then the transmitter node will select the code rates such that R₁>R₂>R₃. FIGS. 3A-3B illustrate an example where the transmitter node defines the code rate of each transmission without requiring feedback or channel estimation between transmissions.

Channel estimation may be performed prior to the first transmission 310, to estimate the channel capacity. The transmitter node may then select the first code rate R₁ to be within the channel capacity. In this example, the code rate for each subsequent l-th transmission may be set by the transmitter node to be Rₗ=R₁/l. Thus, the second code rate for the second transmission is set to be R₂=R₁/2, for example.

The transmitter node performs the first transmission 310 using the first code rate R₁. The first transmitter 310 includes the information blocks 312 of each CB, as well as frozen bits 314. In the present disclosure, the term information block may be used to refer to the set of information bits corresponding to a certain transmission. That is, each transmission may have a corresponding information block, which is the information bits that are relevant to that transmission. The information block that corresponds to a given transmission may include information bits that also belong to the information block of one or more different transmissions. An information block may contain a subset of the information bits belonging to the information block of a different transmission. An information block may contain information bits that are sent in the transmission, or may contain information bits that are used to generate check bits that are sent in the transmission.

The number of information bits in the information block 312 of each CB in the first transmission 310 is equal to the length of each code word multiplied by the code rate of the transmission, which may be mathematically represented as K=N*R₁, where K denotes the number of information bits of each information block 312. In this example, it is assumed that the information blocks 312 of CB1 and CB2 are of equal length, however this is not intended to be limiting. The present disclosure encompasses scenarios in which different CBs have information blocks 312 of different bit lengths, as discussed in other examples further below.

In FIGS. 3A-3B, the bit channels are shown in order of decreasing reliability (leftmost bit channel corresponding to most reliable bit channel; rightmost bit channel corresponding to least reliable bit channel). As shown in FIG. 3A, the frozen bits 314 are placed in the least reliable bit channels. It may be assumed that the K information bits of each information block 312 are ordered based on the reliability of the corresponding bit channels. Then each information block 312 may be represented as a set of information bits as follows:
Information block of

$$CBi = \{ {c}_{1}^{( i )} , {c}_{2}^{( i )} , … , {c}_{K}^{( i )} \} ,$$

i=1, 2
where

$${c}_{j}^{( i )}$$

denotes the j-th information bit of the i-th CB, and the reliability of

$${c}_{m}^{( i )}$$

may be assumed to be higher than that of

$${c}_{n}^{( i )}$$

if m<n.

It should be noted that, if the channel estimation is accurate and the channel is not quickly varying, the transmitter node should be able to select the first code rate R₁ to be within the channel capacity, such that the first transmission 310 should be sufficient to successfully transmit CB1 and CB2 (i.e., the receiver node should successfully decode all the information bits of CB1 and CB2). However, in some cases, the channel may not be estimated correctly and/or the channel may vary quickly such that the transmitter node may not be able to accurately determine the channel capacity for the first transmission. In such cases, the first code rate R₁ may be higher than the channel capacity, with the result that the information bits of CB1 and/or CB2 cannot be successfully decoded by the receiver node after receiving the first transmission 310.

If the information bits of the CBs are not successfully decoded by the receiver node after the first transmission 310, the receiver node may provide feedback (e.g., negative acknowledgement (NACK)) to the transmitter node indicating that a second transmission is needed. In some examples, the transmitter node may perform the second transmission without requiring feedback from the receiver node. If the first transmission 310 was sent to multiple receiver nodes, the transmitter node may perform a second transmission if any one (or more) of the receiver nodes fail to successfully decode the first transmission.

A second transmission 320, as shown in FIG. 3A, is performed with a second code rate R₂ that is lower than the first code rate R₁. That is, the number of information bits in the information blocks 322 corresponding to the second transmission 320 is fewer than the number of information bits in the information blocks 312 of the first transmission. Specifically, the transmitter node selects R₂=R₁/2 for the second transmission 320.

The transmitter node selects a subset of the information bits of each information block 312 of the first transmission 310 for performing the second transmission 320. The selected subsets of information bits form the information blocks 322 denoted as

$${CB}_{1}^{( 2 )} and {CB}_{2}^{( 2 )}$$

(where the superscript 2 denotes the second transmission 320) for the second transmission 320. The information blocks 322 may be referred to in various ways, for example as reduced CBS, retransmission CBs, etc. In particular, the information bits that are selected to form the information blocks 322 for the second transmission 320 are selected from the least reliable bit channels of the first transmission 310, as indicated by shading in FIG. 3A. In this case, because the second transmission 320 has a selected code rate R₂ that is half of R₁, this means that the number of information bits selected for each information block 322 of the second transmission 320 is half of the number of information bits of each information block 312 of the first transmission 310. Symbolically, the information blocks 322 of the second transmission 320 may be represented as follows:

$${CB}_{i}^{( 2 )} = \{ {c}_{K / 2 + 1}^{( i )} , {c}_{K / 2 + 2}^{( i )} , … , {c}_{K}^{( i )} \} , i = 1 , 2$$

The transmitter node generates cross-block check blocks (CCBs) from the bits of the information blocks 322. Specifically, the information bits from each of the information blocks 322 are combined (e.g., by cross-interleaving, using LDPC encoding, using XOR, using linear combination, etc.) to form a set of one or more CCBs that can be sent in the second transmission 320 at the second code rate R2. Further details of how the bits of the information blocks 322 may be combined to generate the CCBs may be found at least in U.S. patent application Ser. No. 16/665,121, previously incorporated by reference. In general, a set of CCBs may be generated by selecting information bits across a plurality of information blocks, then combining the selected information bits to arrive at a set of bits for each CCB. In some examples, the technique for combining the information bits to generate the set of CCBs may be predefined (e.g., in a standard), such as a predefined interleaving sequence that is to be used by the transmitter node to cross-interleave information bits from different information blocks.

As shown in FIG. 3A, there may be two CCBs 324 generated from the information blocks 322, each having the bit size K/2 (i.e., half the size of each information block 312 of the first transmission 310). For example, if the bits of the information blocks 322

$${CB}_{1}^{( 2 )} and {CB}_{2}^{( 2 )}$$

are cross-interleaved to form the two CCBs 324, then the bits of the first CCB 324, denoted

$${CCB}_{1}^{( 2 )} ,$$

may be represented as

$$\{ {c}_{K / 2 + 1}^{( 1 )} , {c}_{K / 2 + 1}^{( 2 )} , {c}_{K / 2 + 2}^{( 1 )} , {c}_{K / 2 + 2}^{( 2 )} , … , {c}_{3 K / 4}^{( 1 )} , {c}_{3 K / 4}^{( 2 )} \}$$

and the bits of the second CCB 324, denoted

$${CB}_{2}^{( 2 )} ,$$

may be represented as

$$\{ {c}_{3 K / 4 + 1}^{( 1 )} , {c}_{3 K / 4 + 1}^{( 2 )} , {c}_{3 K / 4 + 2}^{( 1 )} , {c}_{3 K / 4 + 2}^{( 2 )} , … , {c}_{K}^{( 1 )} , {c}_{K}^{( 2 )} \} .$$

The two CCBs 324 may be sent in the second transmission 320. It should be noted that because the second transmission 320 is at a lower code rate than the first code rate of the first transmission 310, the number of frozen bits 326 in the second transmission 320 is greater than the number of frozen bits 314 in the first transmission.

If both

$${CCB}_{1}^{( 2 )} and {CCB}_{2}^{( 2 )}$$

are decoded successfully by the receiver node after the second transmission 320, the information bits belonging to the information blocks 322 may be recovered (e.g., by the receiver node undoing the cross-interleaving or other combination technique that was used to generate the CCBs 324). It should be noted that the information blocks 322 corresponding to the second transmission 320 contain a subset of the information bits of the information blocks 312 corresponding to the first transmission 310. Thus, the recovered information bits of the information blocks 322 can be set as the frozen bits in the polar decoders for decoding the information bits of the originally transmitted information blocks 312 of CB1 and CB2. As a result, the number of information bits that need to be decoded in each CB is reduced from K bits to K−K/2=K/2 bits. The effect is that the code rate of the first transmission 310 is effectively reduced from R₁ to R₁/2, so the overall code rate of both the first and second transmissions 310, 320 is R₁/2. If the channel capacity is greater than or equal to this reduced code rate, both CB1 and CB2 can be successfully decoded at the receiver node. In some cases, if only one CCB 324 is decoded successfully decoded after the second transmission 320, the information bits recovered from the successfully decoded CCB 324 may still be passed to assist in polar decoding of the CBs of the first transmission 310 (e.g., set as frozen bits), to help improve the decoding performance. If one CB from the first transmission 310 is successfully decoded after the first transmission 310, the information bits of the successfully decoded CB can be set as the frozen bits to assist in decoding of the CCBs 324 after the second transmission 320, which may help to improve the decoding performance after the second transmission 320.

If some CBs from the first transmission 310 are still not successfully decoded by the receiver node after the second transmission 320, the transmitter node may perform a third transmission 330, as shown in FIG. 3B. The third transmission 330 may be performed in response to feedback from one or more receiver nodes, or without requiring feedback, as previously described.

The third transmission 330 is performed with a third code rate, denoted R₃, that is lower than the first code rate R₁ and also lower than the second code rate R₂. In this example, the transmitter node selects the third code rate R₃ to be R₁/3.

The transmitted node selects a subset of information bits from the information blocks 312 of the first transmission 310 as well as from the information blocks 322 of the second transmission 320. As illustrated through the use of a thick outline in FIG. 3B, the selected information bits are selected from the least reliable bit channels of the information blocks 322 of the second transmission 320, and also selected from the least reliable bit channels next to the previously selected information bits of the information blocks 312 of the first transmission 310. That is, the information bits that are selected to form the information blocks 332 of the third transmission 330 are selected from the least reliable, previously unselected bit channels of the information blocks of each prior transmission. For example, the information bits in the least reliable bit channels of the information blocks 312 of the first transmission 310 were previously selected for performing the second transmission 320. Thus, the information bits that are selected for the information blocks 332 of the third transmission are selected from the next lowest reliable bit channels (i.e., the least reliable bit channels that have not yet been selected), as indicated by the thick outline in FIG. 3B. On the other hand, none of the bit channels of the information blocks 322 of the second transmission 320 were previously selected. Thus, the information bits in the least reliable bit channels of the information blocks 322 are selected to form the information blocks 332 of the third transmission, as indicated by the thick outline.

Since the third code rate R₃ is selected to be one-third of the first code rate R₁, the bit size of each of the information blocks 332 should be K/3 (i.e., one-third the bit size of the information blocks 312). FIG. 3B illustrates two information blocks 332, denoted

$${CB}_{1}^{( 3 )} and {CB}_{2}^{( 3 )} ,$$

which are formed using K/6 information bits selected from the information block 312 of the first transmission 310 and K/6 information bits selected from the information block 322 of the second transmission 320.

In the example shown, the set of information bits selected for each information block 332 of the third transmission 330 may be represented as follows:

$${CB}_{i}^{( 3 )} = \{ {c}_{\frac{K}{3} + 1}^{( i )} , ... , {c}_{\frac{K}{2}}^{( i )} , {c}_{\frac{5 K}{6} + 1}^{( i )} , ... {c}_{K}^{( i )} \} , i = 1 , 2$$

The transmitter node generates a set of CCBs 334 (e.g.,

$${CCB}_{1}^{( 3 )} and {CCB}_{2}^{( 3 )}$$

as shown in FIG. 3B) by combining the bits of the information blocks 332 using any of the techniques previously described, such as cross-interleaving. The generated set of CCBs 334, with a set of frozen bits 336, is then set in the third transmission 330 to the receiver node.

FIG. 3C illustrates how successfully decoding the third transmission 330 may assist in decoding the first and second transmissions 310, 320. In particular, FIG. 3C illustrates a successive decoding process that involves passing back successfully decoded information bits to assist in decoding a previous transmission.

For ease of understanding, the CCBs 324, 334 that are actually received by the receiver node in the second and third transmissions 320, 330 are not shown. However, it should be understood that the information blocks 322, 332 are not directly received by the receiver node in the second and third transmissions 320, 330, but rather are recovered from the respective decoded CCBs 324, 334 by the receiver node. The receiver node has information (e.g., sent by the transmitter node in a control signal, such as a downlink control information (DCI) signal, an uplink control information (UCI) signal, or a sidelink control information (SCI) signal; or predefined in a standard) about how the CCBs 324, 334 are generated by combining (e.g., cross-interleaving) the information bits of the respective information blocks 322, 324. The receiver node uses this information to undo the combining (e.g., undo the cross-interleaving) and recover the respective information blocks 322, 324, after first successfully decoding the CCBs 324, 334.

In this example, the receiver node successfully decodes both

$${CCB}_{1}^{( 3 )} and {CCB}_{2}^{( 3 )}$$

after the third transmission 330 (meaning the channel capacity is greater than or equal to the third code rate R₃), and the information blocks 332 can be recovered. Recall that there are K information bits in each of the information blocks 312 of the first transmission 310, K/2 information bits in each of the information blocks 322 of the second transmission 320, and K/3 information bits in each of the information blocks 332 of the third transmission 330. Because the information blocks 332 include information bits selected from the information blocks of all previous transmission (in this example, K/6 bits selected from the information blocks 322 of the second transmission 320 and another K/6 bits selected from the information blocks 312 of the first transmission 310, as denoted by shading and thick outlining), the information bits of the recovered information blocks 332 can be passed (indicated by curved arrows) to be used as frozen bits, to assist in decoding the information blocks 332, 312 of the second transmission 320 and the first transmission 310. This enables the code rate of the second transmission 320 to be effectively reduced, because K/6 information bits (which were successfully decoded after the third transmission 330) can be set to frozen bits, reducing the information bits from K/2 to (K/2−K/6)=K/3. Thus, the code rate of the second transmission 320 can be effectively reduced from R₁/2 to R₁/3. Because the channel capacity is greater than or equal to R₃ and R₃=R₁/3, this means that the remaining information bits in the information blocks 322 of the second transmission 320 can be successfully decoded by the receiver node.

The receiver node successfully decodes the information blocks 322 and the information bits of the information blocks 322 are passed (indicated by a curved arrow) to be used as frozen bits to assist in decoding the first transmission 310. Thus, when the receiver node now attempts to decode the first transmission 310, the K/6 information bits of the information blocks 332 successfully recovered from the third transmission 330 as well as the K/2 information bits of the information blocks 322 successfully recovered from the second transmission 320 can be used as frozen bits to reduce the effective code rate of the first transmission 310. In this example, the number of information bits of the information blocks 310 that remain to be recovered is equal to (K−K/2−K/6)=K/3, thus the effective code rate becomes R₁/3. Because the channel capacity is greater than or equal to R₃ and R₃=R₁/3, this means that the remaining information bits in the information blocks 312 of the second transmission 310 can be successfully decoded by the receiver node. Thus, it can be observed that the overall code rate of all transmissions 310, 320, 330 equals R₁/3. The receiver node may send feedback (e.g., ACK) to the transmitter node to indicate all the information bits of the CBs have been successfully decoded.

The example of FIGS. 3A-3C may be generalized for any number of CBs sent in the first transmission and any number of transmissions based on the information bits of the first transmission. In this example, the transmitter node selects the code rate for the first transmission based on, for example, channel estimation. If the code rate selected for the first transmission (also referred to as the initial transmission) is denoted R, then the transmitter node selects the code rate for each subsequent l-th transmission (also referred to as a retransmission) to be R/l.

In the present disclosure, if there are L transmissions required to successfully decode all the information bits of the first transmission, the L transmissions may be referred to as a set of transmissions. A subsequent transmission that involves different information bits is not considered to be part of the set of L transmissions (but may be part of a subsequent different set of transmissions).

Consider the generalization where there are M information blocks (denoted as CB1 to CBM) sent by the transmitter node in the first transmission, and the set of information blocks at l-th transmissions is denoted as

$${\{ {CB}_{m}^{( l )} \}}_{m = 1}^{M} .$$

Supposing that all information blocks have not yet been successfully decoded after L−1 transmissions. For the L-th transmission, the transmitter node selects a code rate of R/L. The information bits that are selected to generate the CCBs for the L-th transmission are selected from the lowest reliable bit channels that have not been previously selected by any of the previous L−1 transmissions. If the bit channels are ordered and indexed from highest to lowest reliability (i.e., a lower-indexed bit channel is more reliable than a higher-indexed bit channel), then information bits located on the indices of

$${\{ {CB}_{m}^{( L - 1 )} - {CB}_{m}^{( L )} \}}_{m = 1}^{M}$$

in all previous (L−1) transmission are selected to obtain the set of information blocks for the L-th transmission, denoted as

$${\{ {CB}_{m}^{( L )} \}}_{m = 1}^{M} .$$

The information bits in this set of information blocks are combined (e.g., using any suitable combining technique, such as cross-interleaving) to generate the set of one or more CCBs for the L-th transmission, denoted as

$${\{ {CCB}_{m}^{( L )} \}}_{m = 1}^{M} ,$$

that is then transmitted in the L-th transmission. It may be noted that the number of information bits in

$${CB}_{m}^{( L - 1 )} - {CB}_{m}^{( L )}$$

for all (L−1) transmissions equals (L−1)*(N*R/(L−1)−N*R/L)=N*(R/L), and the size of

$${CCB}_{m}^{( L )}$$

is the same with that of

$${CB}_{m}^{( L )}$$

(i.e., the bit size of each of the generated CCBs that are sent in the L-th transmission is the same as the bit size of each of the information blocks of the L-th transmission), for all m=1, 2, . . . , M. Therefore, the L-th transmission satisfies the code rate R/L. Using the successive decoding process described above, if the information bits in the L-th transmission are successfully recovered, then the decoded information bits are passed back to enable successful decoding of the (L−1)-th transmission, and so forth.

In some examples, the transmitter node may select a code rate for each transmission that is not necessarily equal to R/l for the l-th transmission. A retransmission scheme is now discussed where the code rate selected by the transmitter node for each transmission in a set of transmissions may be generalized to any arbitrary code rate. However, the code rate for each transmission should be lower than the code rate of every previous transmission in the same set of transmissions.

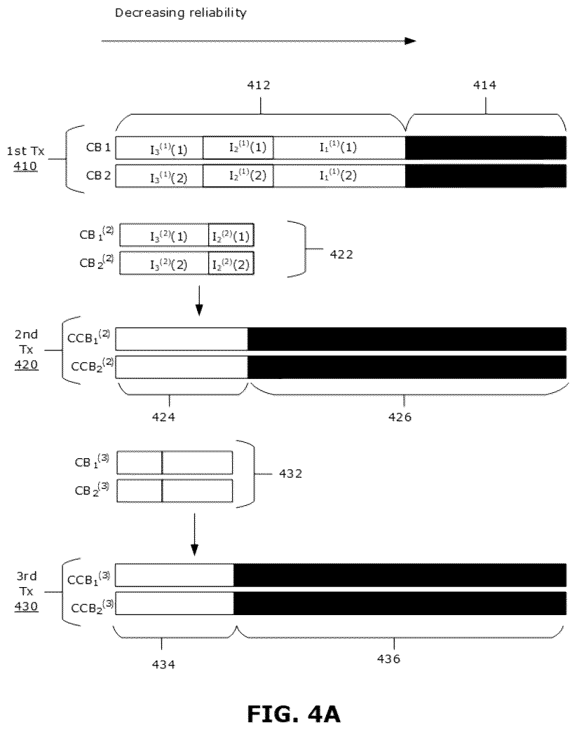

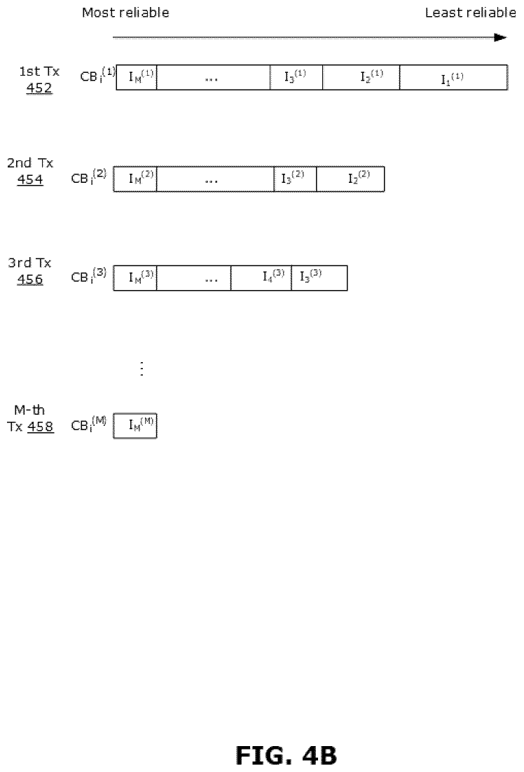

FIG. 4A illustrates a first transmission 410 at a first code rate R₁, followed by a second transmission 420 at a second code rate R₂, and followed by a third transmission 430 at a third code rate R₃. The code rates R₁, R₂, R₃ may be arbitrary, provided R₁>R₂>R₃. For example, the transmitter node may select the code rate for each transmission based on channel estimation performed prior to each transmission, or based on feedback from the receiver node after each transmission indicating a code rate for the next transmission (e.g., feedback from the receiver node indicating the amount of correctly determined frozen bits may be used to estimate the code rate that should be selected for the next transmission). In other examples, the transmitter node may select the code rate for each transmission based on preset code rates (e.g., according to a standard). In this example, it may be assumed that the channel capacity is greater than or equal to R₃, meaning a transmission with code rate of R₃ or lower can be successfully decoded by the receiver node. However, this channel capacity may not be accurately estimated by the transmitter node.

The transmitter node may determine that three transmissions are to be performed based on a preset number of transmissions (e.g., in the case where transmissions are performed without any feedback from the receiver node), based on feedback from the receiver node after the first and second transmissions 410, 420 (e.g., in the case where the receiver node sends back NACK when decoding is unsuccessful), or based on absence of feedback from the receiver node after the first and second transmissions 410, 420 (e.g., in the case where the receiver node only sends back ACK when decoding is successful and no feedback when decoding is unsuccessful). If there are multiple receiver nodes (e.g., in the case of a multicast, groupcast or broadcast), failure of any one receiver node to successfully decode a transmission may cause the transmitter node to send another transmission to all receiver nodes that are intended recipients, or to only the receiver node that was unsuccessful. It should be understood that the retransmission scheme disclosed herein may be adapted to any suitable feedback mechanism.

In the first transmission 410, the information bits of two CBs, namely CB1 and CB2, form the information blocks 412 (it should be understood that there may be more than two CBs). Let A₁(i) denote the set of information bits of CBi, i=1, 2. The number information bits of each information block 412 of the first transmission 410 is |A₁(i)|=K=N₁R₁ where N₁ refers to the number of coded bits (i.e., the codeword length). The information blocks 412 and frozen bits 414 are sent in the first transmission 410.

The transmitter node determines that a second transmission 420 is required (e.g., based on feedback, lack of feedback, or preset number of transmissions, etc.).

In the second transmission 420, information bits of each information block 412 are selected to form the information blocks 422 of the second transmission 420. If the two information blocks 412 contain respective sets of information bits denoted as A₂(1) and A₂(2), then the set of information bits in each information block 412 may be represented as:

$${A}_{2} ( i ) = {I}_{1}^{( 1 )} ( i ) , i = 1 , 2$$

where

$${I}_{1}^{( 1 )} ( i )$$

is a subset or the information bits of each information block 412 (denoted A₁(i)) of the first transmission 410.

Similar to the example of FIGS. 3A-3C, the information bits selected to form the information blocks 422 are selected from the least reliable bit channels of the first transmission 410. However, because the code rate R₂ may be arbitrary, the number of selected information bits should be defined such that if the selected information bits are all successfully recovered after the second transmission 420 (meaning the channel capacity is greater than or equal to R₂) and set as frozen bits, the remaining information bits of the first transmission 410 result in an effective code rate of R₂ (and thus can also be successfully recovered. The number of selected information bits selected from the first transmission 410 may be determined according to the following:

$$\vert {I}_{1}^{( 1 )} ( i ) \vert = {N}_{1} {R}_{1} - {N}_{1} {R}_{2}$$

where

$${I}_{1}^{( 1 )} ( i )$$

denotes the set of information bits selected from the respective i-th information block 412 (i=1, 2), N₁ denotes the codeword length for the first transmission 410, and N₁R₁=K is the total number of information bits in each information block 412. Thus, if the selected information bits

$${I}_{1}^{( 1 )} ( i )$$

can be successfully recovered and used as frozen bits, then there remains only N₁R₂ information bits to be decoded, resulting in an effective code rate of R₂ as desired.

The codeword length N₂ of the second transmission 420 is determined by the transmitter node such that

$${N}_{1} + {N}_{2} = \frac{K}{{R}_{2}}$$

(or such that

$${N}_{2} {R}_{2} = \vert {I}_{1}^{( 1 )} \vert ) .$$

When N₂ is determined in this way, it can be proven that the second transmission 420 achieves a code rate R₂:

$$\vert {A}_{2} ( i ) \vert = {N}_{1} {R}_{1} - {N}_{1} {R}_{2} = K - \frac{{N}_{1} K}{{N}_{1} + {N}_{2}} = {N}_{2} {R}_{2}$$

The transmitter node generates the CCBs 424 (denoted

$${CCB}_{1}^{( 2 )} , {CCB}_{2}^{( 2 )} )$$

by combining the information bits of the information blocks 422 as previously discussed (e.g., via cross-interleaving). The CCBs 424 are sent with frozen bits 426 in the second transmission 420.

The transmitter node determines that a third transmission 430 is required (e.g., based on feedback, lack of feedback, or preset number of transmissions, etc.).

In the third transmission 430, information bits are selected from each information block of each prior transmission. Let the sets of information bits of the information blocks 432 be denoted as A₃(1) and A₃(2). The information bits A₃(i) are selected from the information blocks 412, 422, represented by:

$${A}_{3} ( i ) = {I}_{2}^{( 2 )} ( i ) ⋃ {I}_{2}^{( 1 )} ( i )$$

where

$${I}_{2}^{( 1 )} ( i )$$

are bits selected from the lowest reliable bit channels of the first transmission 410 that were not previously selected for the second transmission 420, and

$${I}_{2}^{( 2 )} ( i )$$

are bits selected from the least reliable bit channels of the second transmission 420.

In particular, the number of information bits selected from each information block 412, 422 may be determined in order to achieve a desired effective code rate of R₃ over all the transmissions. This may be achieved by selecting the number of information bits in a similar manner as that described above with respect to the second transmission 420:

$$\vert {I}_{2}^{( 1 )} ( i ) \vert = {N}_{1} {R}_{2} - {N}_{1} {R}_{3}$$

$$\vert {I}_{2}^{( 2 )} ( i ) \vert = {N}_{2} {R}_{2} - {N}_{2} {R}_{3}$$

To achieve the desired code rate R₃ for the third transmission 430, codeword length N₃ may be selected such that that N₁+N₂+N₃=K/R₃. It can be proven that the third transmission 430 achieves a code rate of R₃ as follows:

$$\begin{matrix}\vert {A}_{3} ( i ) \vert = {N}_{1} {R}_{2} - {N}_{1} {R}_{3} + {N}_{2} {R}_{2} - {N}_{2} {R}_{3} \\ = ( {N}_{1} + {N}_{2} ) {R}_{2} - ( {N}_{1} + {N}_{2} ) {R}_{3} \\ = K - \frac{( {N}_{1} + {N}_{2} ) K}{{N}_{1} + {N}_{2} + {N}_{3}} = {N}_{3} {R}_{3}\end{matrix}$$

CCBs 434 are generated by combining the information bits of the information blocks 432 (e.g., using cross-interleaving). The CCBs 434 and frozen bits 436 are sent in the third transmission 430.

From the above discussion, it may be appreciated that the information blocks 412 of the first transmission 410 may be conceptually partitioned into three disjoint subsets of information bits

$$\{ {I}_{1}^{( 1 )} ( i ) , {I}_{2}^{( 1 )} ( i ) , {I}_{3}^{( 1 )} ( i ) \} ,$$

i=1, 2 where the subsets

$${I}_{1}^{( 1 )} ( i ) , {I}_{2}^{( 1 )} ( i )$$

are the information bits selected by the transmitter node for the second and third transmissions 420, 430, respectively (and that, at the receiver node, are passed back to be used as frozen bits during successive decoding, after successful decoding of the third and second transmissions 430, 420), and the subset

$${I}_{3}^{( 1 )} ( i )$$

is the set of information bits that remains to be recovered after successfully recovering the information blocks 432, 422 of the third and second transmissions 430, 420. Similarly, the information blocks 422 of the second transmission 420 may be conceptually partioned into the two disjoint subsets of information bits

$$\{ {I}_{2}^{( 2 )} ( i ) , {I}_{3}^{( 2 )} ( i ) \} ,$$

i=1, 2 where the subset

$${I}_{2}^{( 2 )} ( i )$$

is the set or information pits selected by the transmitted node for the third transmission 430 (and that, at the receiver node, is passed back to be used as frozen bits during successive decoding, after successful decoding of the third transmission 430), and the subset

$${I}_{3}^{( 2 )} ( i )$$

is the set of information bits that remains to be recovered after successfully recovering the information block 432 of the third transmission 430.

The receiver node may perform successive decoding, as previously described. In this example, the receiver node successfully decodes the CCBs 434 and recovers the information bits of the information blocks 432 after the third transmission 430. That is, the information bits can be successfully recovered with a code rate of R₃. The recovered information bits are passed back to be used as frozen bits to assist in decoding the second and first transmissions 420, 410.

For decoding the second transmission 420, (N₂R₂−N₂R₃) information bits are passed from successful decoding of the third transmission 430 and set as frozen bits. The number of remaining information bits that need to be decoded in each information block 422 is N₂R₂−(N₂R₂−N₂R₃)=N₂R₃. This corresponds to the effective code rate R₃, allowing the second transmission 420 to be decoded and all information bits of the information blocks 422 to be successfully recovered. The recovered information bits are passed back to be used as frozen bits to assist in decoding the first transmission 410.

For decoding the first transmission 410, (N₁R₂−N₁R₃) and (N₁R₁−N₁R₂) information bits are passed from successful decoding of the third and second transmissions 430, 420 and set as frozen bits. The number of remaining information bits that need to be decoded in each information block 412 is N₁R₁−(N₁R₂−N₁R₃)−(N₁R₁−N₁R₂)=N₁R₃. This corresponds to the effective code rate R₃, allowing the first transmission 410 to be decoded and all information bits of the original CB1 and CB2 can be successfully recovered. The receiver node may send feedback (e.g., ACK) to the transmitter node to indicate all the information bits of the CBs have been successfully decoded.

The example of FIG. 4A may be generalized to a set of transmissions with any number of transmissions and any arbitrary code rate for each transmission, provided the code rate for each transmission is lower than every prior transmission in the set of transmissions.

Consider the scenario shown in FIG. 4B where there are M transmissions performed in a set of transmissions for transmitting K information bits. FIG. 4B illustrates the information blocks for the first transmission 452, second transmission 454, third transmission 456, and M-th transmission 458, for an arbitrary value of M. There may be any arbitrary number of CBs send in the first transmission (only one is shown for simplicity), and the index i may be any suitable number.

The code rates for the M transmissions are denoted R₁, R₂, . . . , R_{M} and the block-lengths (also referred to as codeword length or number of coded bits) are denoted N₁, N₂, . . . , N_{M}. At the m-th transmission, the block-length Nₘ used for CB or CCB of the transmission is selected by the transmitter node so that the decoding the overall effective code rate, when the m-th transmission is successfully decoded at the successive decoder at the receiver node, is Rₘ for all transmissions up to the m-th transmission (i.e., from the first transmission up to the m-th transmission). This means that the transmitter node selects the block-length for each transmission such that N₁+N₂+ . . . +Nₘ=K/Rₘ.

At the m-th transmission, the information bits of each information block

$$C {B}_{i}^{( m )}$$

conceptually partitioned into (M−m+1) disjoint subsets, which may be denoted

$${I}_{M}^{( m )} , {I}_{M - 1}^{( m )} , … , {I}_{m}^{( m )} .$$

The bit size of each subset of information bits may be defined as:

$$\vert {I}_{l}^{( m )} \vert = ( {N}_{m} {R}_{l} - {N}_{m} {R}_{l + 1} ) , l = 1 , … , M - 1 , and \vert {I}_{M}^{( m )} \vert = {N}_{m} {R}_{M} .$$

The partitioning of the information block into subsets of information bits may be similar to the procedure described by Hong et al., mentioned previously. However, in the present disclosure, information bits from all the information blocks of a given transmission are combined (e.g., by cross-interleaving information bits from different information blocks), in order to generate the CCBs and perform cross-block coding. The partitioning of the information block may be performed by the transmitter node at each transmission. Alternatively, if the number of transmissions, M, and the code rates Rₘ are predefined for all transmissions, the transmitter node may define the subsets of information bits at the start of transmission and may simply select the information bits according to the defined subsets at each transmission.

At the m-th transmission, the CCBs are generated from the information bits selected across the set of information blocks

$$\{ C {B}_{i}^{( m )} \} ,$$

where each information block

$$C {B}_{i}^{( m )}$$

includes (m−1) subsets of information bits from each of the previous (m−1) transmissions. That is, each i-th information block

$$C {B}_{i}^{( m )}$$

includes a subset of information bits from each of the i-th information block of the previous (m−1) transmissions, specifically a subset from each of

$$\{ C {B}_{i}^{( 1 )} , … , {CB}_{i}^{( m - 1 )} \} .$$

Thus, the information block

$$C {B}_{i}^{( m )}$$

contains the set or information bits

$${A}_{m} = {I}_{m - 1}^{( m - 1 )} ⋃ {I}_{m - 1}^{( m - 2 )} ⋃ … ⋃ {I}_{m - 1}^{( 1 )} .$$

It can be shown that the number of information bits in each information block

$$C {B}_{i}^{( m )}$$

satisfies the requirement that |Aₘ|=NₘRₘ.

Thus, after receiving and successfully decoding the CCBs of the m-th transmission at a code rate of Rₘ, the receiver node may recover the information bits of the information blocks

$$C {B}_{i}^{( m )}$$

and pass the recovered subset of information bits of the (m−1)-th transmission (i.e., the subset

$${I}_{m - 1}^{( m - 1 )} )$$

to be used as frozen bits for decoding the (m−1)-th transmission. This lowers the effective code rate of the (m−1)-th transmission to Rₘ, enabling successful decoding and recovery of the information bits of the information blocks

$$C {B}_{i}^{( m - 1 )} .$$

This process may be continued, using successive decoding, until the information bits of the original CBs of the first transmission are all recovered.

In general, the CBs of the first transmission may or may not be similar in bit size (where two CBs are similar in bit size when they differ in size by no more than 1 or 2 bits). It should be noted that although FIGS. 3A-3C and 4A illustrate the information blocks of the first transmission having similar sizes, this is not intended to be limiting. The previously described examples may be implemented in cases where the first transmission has information blocks (or CBs) of different bit sizes (that is, where the CBs differ in size by more than 1 or 2 bits).

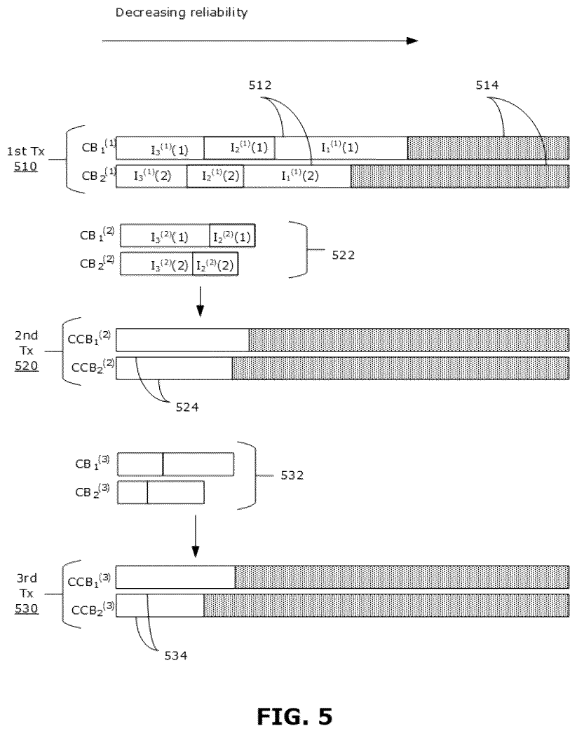

FIG. 5 illustrates a set of three transmissions 510, 520, 530, similar to the set of transmissions shown in FIG. 4A, however FIG. 5 more clearly illustrates the difference in bit size of each information block.

As illustrated in FIG. 5, the information blocks 512 of the first transmission 510, generically denoted

$$C {B}_{i}^{( 1 )} ,$$

are different in size (it may also be noted that the frozen bits 514 are different in number). The number of information bits of each information block

$${CB}_{i}^{( 1 )}$$

may be represented as |A₁(i)|=K(i)=N₁(i)R₁(i), i=1, 2, where N₁(i) denotes the codeword length of the i-the information block and R₁(i) denotes the code rate of the i-th information block of the first transmission 510.

The information bits that are selected to form the information blocks 522 of the second transmission 520, generically denoted

$$C {B}_{i}^{( 2 )} ,$$

are selected according to

$${A}_{2} ( i ) = {I}_{1}^{( 1 )} ( i ) = {N}_{1} ( i ) {R}_{1} ( i ) - {N}_{1} ( i ) {R}_{2} ( i ) ,$$

i=1, 2, where R₂(i) denotes the code rate of the i-th information block of the second transmission 520. To generate the CCBs 524, the transmitter node selects information bits from across the information blocks

$$C {B}_{i}^{( 2 )}$$

such that the number of bits of

$${CCB}_{i}^{( 2 )}$$

is equal to the number of information bits of

$$C {B}_{i}^{( 2 )} .$$

That is, the number of bits in

$${CCB}_{1}^{( 2 )}$$

is equal to the number of bits of

$$C {B}_{1}^{( 2 )} ,$$

and the number or bits in

$${CCB}_{2}^{( 2 )}$$

is equal to the number of bits of

$$C {B}_{2}^{( 2 )} .$$

This means that the CCBs 524 are also different in size. Specifically, for generating each

$${CCB}_{i}^{( 2 )} ,$$

the number of information pits selected from the information blocks

$$C {B}_{i}^{( 2 )}$$

may be proportional to |A₂(i)|, i=1, 2. Consider a simplified example where

$$C {B}_{1}^{( 2 )}$$

is twice the size of

$$C {B}_{2}^{( 2 )} ,$$

that is |A₂(1)|=2|A₂(2)|. This means that

$${CCB}_{1}^{( 2 )}$$

should also be twice the size of

$${CCB}_{2}^{( 2 )} .$$

Further, two-thirds of the information bits of

$${CB}_{1}^{( 2 )}$$

and two-third of the information bits of

$${CB}_{2}^{( 2 )}$$

are selected to generate

$${CCB}_{1}^{( 2 )} ,$$

whereas only one-third of the information bits of

$${CB}_{1}^{( 2 )}$$

and one-third of the information bits of

$${CB}_{2}^{( 2 )}$$

are selected to generate

$${CCB}_{2}^{( 2 )} .$$

More generally, if there are L information blocks for the m-th transmission, then the fraction of information bits selected from information block

$${CB}_{i}^{( m )}$$

to generate

$${CCB}_{i}^{( m )}$$

may be selected by the transmitter node to be

$$\vert {A}_{m} ( i ) \vert / {\sum }_{j = 1}^{L} \vert {A}_{m} ( j ) \vert .$$

For performing the third transmission 530, the information bits selected for each information block 532, generically denoted

$${CB}_{i}^{( 3 )} ,$$

is selected according to:

$${A}_{3} ( i ) = {I}_{2}^{( 2 )} ( i ) ⋃ {I}_{2}^{( 1 )} ( i ) , i = 1 , 2$$

$$\vert {I}_{2}^{( 2 )} ( i ) \vert = {N}_{2} ( i ) {R}_{2} ( i ) - {N}_{2} ( i ) {R}_{3} ( i )$$

$$\vert {I}_{2}^{( 1 )} ( i ) \vert = {N}_{1} ( i ) {R}_{2} ( i ) - {N}_{1} ( i ) {R}_{3} ( i )$$

where R₃(i) denotes the code rate of the i-th information block of the third transmission 530. Then, to generate each of the CCBs 534, information bits are selected from each

$$C {B}_{i}^{( 3 )}$$

proportionally as described above.

As previously mentioned, after the receiver node successfully decodes the CCBs received in a given transmission, the receiver node further needs to recover the information bits of each information block from the decoded CCBs. For example, the receiver node may undo the combining (e.g., under the cross-interleaving) of the information bits using information provided by the transmitter node. If the CCB generation technique is not predefined (e.g., in a standard), there may be a need for the transmitter node to provide information (e.g., control information) about how the CCBs were generated. Additionally, in some examples the transmitter node may select the code rate for each transmission based on feedback from the receiver node. Thus, there may be a need for the receiver to provide feedback information indicating the code rate to use for the next transmission.

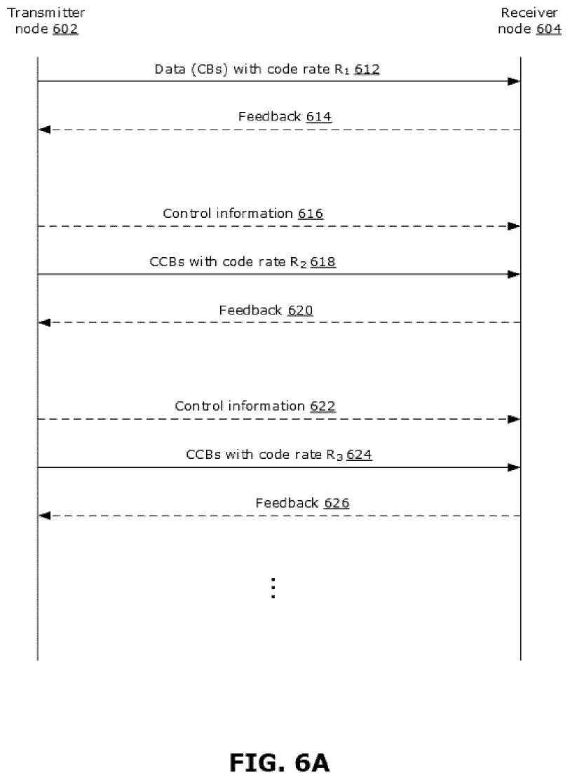

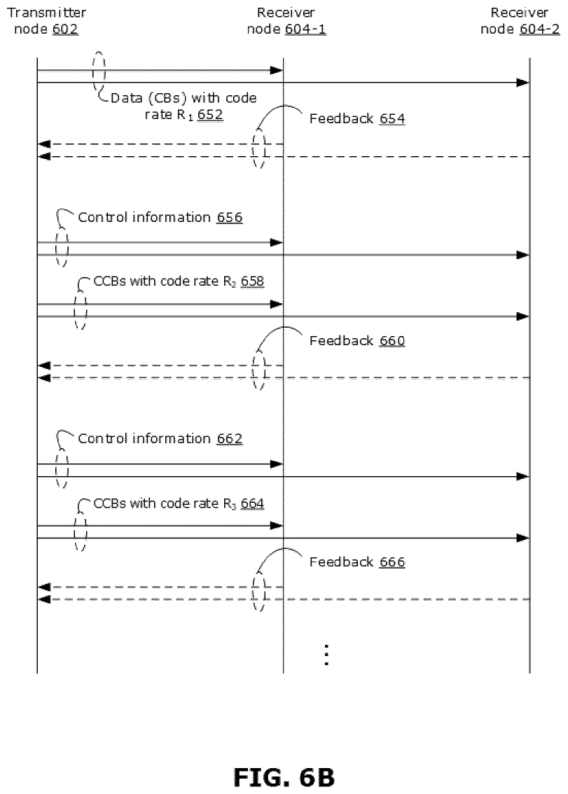

FIG. 6A is a signaling diagram illustrating an example of signal flow for performing a set of polar coding transmissions, using CCBs for one or more retransmissions. FIG. 6A illustrates signaling between a transmitter node 602 and one receiver node 604. In examples of DL transmission, the transmitter node 602 may be a BS 170 and the receiver node 604 may be a UE 110. In examples of UL transmission, the transmitter node 602 may be a UE 110 and the receiver node 604 may be a BS 170. In examples of SL transmissions, the transmitter node 602 may be a UE 110 and the receiver node 604 may be a different UE 110.

The transmitter node 602 transmits data (in the form of CBs) with a first code rate R₁ in a first transmission 612 to the intended receiver node 604. Although not shown in FIG. 6A, for simplicity, the receiver node 604 may receive control information prior to the first transmission 612 from the transmitter node 602. The control information may be received as a DCI signal, a UCI signal, or a SCI signal, depending on the DL, UL or SL scenario. The control information that is received by the receiver node 604 prior to the first transmission 612 may provide information about the resource block on which data is to be received, the modulation and coding scheme used, the redundancy version and other information that may be used by the receiver node 604 to decode the data.

The receiver node 604 performs a decoding attempt. Optionally, the receiver node 604 may provide feedback 614 back to the transmitter node 602, for example to indicate that decoding of all the CBs was not successful (e.g., NACK). Optionally, in additional to ACK (indicating decoding was successful) or NACK (indicating decoding was not successful), the feedback 614 may include additional information that may be used by the transmitter node 602 to select the code rate for a subsequent transmission.

For example, the receiver node 604 may provide feedback based on the number of correct decoding decisions on the frozen bits in the polar decoder. In an example implementation, the number of correct decoding decisions may be mapped to an index value. If n bits are used to transmit the index value, possible index values may be defined by the index set l={1, 2, 3, . . . , 2ⁿ−1, 2ⁿ}. Each index value in the set I uniquely corresponds to a respective fraction value in the defined fraction set

$$F = \{ \frac{1}{{2}^{n}} , \frac{2}{{2}^{n}} , \frac{3}{{2}^{n}} , … , \frac{{2}^{n} - 1}{{2}^{n}} , 1 \} .$$

The number of bits n and a mapping table that maps the index set/to the fraction set F may be predefined (e.g., in a standard) and may be known to both the receiver node 604 and the transmitter node 602. The receiver node 604 may compute the fraction of correct decoding decisions on the frozen bits, identify the fraction value in the set F that is closest to the computed fraction and feedback the index value that corresponds to the identified fraction value. For example, if 7/32 of the decoding decisions on the frozen bits are correct, the closest fraction value in the set Fis 4/16, which corresponds to the index value 16, or the bit value [10000]. This index value may be included in the feedback 614 to the transmitter node 602. Such feedback 614 may provide information to enable the transmitter node 602 to estimate the code rate to be used for the next transmission. In some examples, such feedback 614 may be considered a form of channel quality/capacity feedback.

Other forms of feedback may be provided to the transmitter node 602. For example, any form of channel quality indicator (CQI) feedback may be provided to the transmitter node 602.

The transmitter node 602 may use information included in the feedback 614 to determine the code rate for the second transmission. For example, if the index value i is included in the feedback 614, the transmitter node 602 may map the index value back to the fraction value f (e.g., the relationship between the index set I and the fraction set F may be predefined and known to both the receiver node 604 and the transmitter node 602). Then the transmitter node 602 may select the second code rate R₂ for the second transmission to be

$${R}_{2} = {R}_{1} / f .$$

In some examples, there may be no feedback 614 from the receiver node 604 (e.g., absence of ACK may indicate unsuccessful decoding, or the transmitter node 602 may perform a predefined number of transmissions in an ACK/NACKless scheme). The transmitter node 602 may perform channel estimation to determine the second code rate R₂, or may use a predefined second code rate (e.g., R₂=R₁/2).

Optionally, the transmitter node 602 may send control information 616 to the receiver node 604 prior to the second transmission. The control information 616 may be sent as a DCI signal, a UCI signal, or a SCI signal, depending on the DL, UL or SL scenario. The control information 616 may include information about how the CCBs (which will be transmitted in the second transmission) are generated. For example, the transmitter node 602 may include information about the interleaving sequence used to cross-interleave information bits across multiple information blocks. Alternatively, the CCB generation method may be pre-configured in advance (e.g., defined by a standard) so information about CCB generation need not be included in the control information 616.

The control information 616 may include the code rate R₂ selected for the second transmission. For example, if the code rate R₂ is selected by the transmitter node 602 without feedback from the receiver node 604, the receiver node 604 may not otherwise have information about the selected code rate R₂ (unless the code rate R₂ is predefined in a standard, for example, in which case the receiver node 604 may not need to be informed via the control information 616). In some examples, such as in multicast, groupcast or broadcast scenarios (described in more detail with respect to FIG. 6B), the transmitter node 602 may receive feedback from multiple receiver nodes and may select the code rate R₂ based on the lowest code rate indicated in all of the received feedback. In such a scenario, the transmitter node 602 may need to provide all receiver nodes with information about the selected code rate despite each receiver node providing feedback indicating the code rate.

In some examples, such as if there is only one receiver node 604 and the transmitter node 602 selects the code rate R₂ based on the feedback 614, it may not be necessary for the transmitter node 602 to indicate the selected code rate R₂ in the control information 616. This is because the receiver node 604 may already know (e.g., based on a standard) how the transmitter node 602 selects code rate based on the feedback 614 and thus can determine that the transmitter node 602 will select the code rate R₂ based on the feedback 614.

After any optional control information 616 is transmitted, the transmitter node 602 performs a second transmission 618 (which may be referred to as a retransmission, since the first transmission may be referred to as the initial transmission) of CCBs generated from selected information bits (as described previously) using the selected code rate R₂.

The receiver node 604 may, after receiving the second transmission 618, perform a decoding attempt to decode the CCBs and recover the information bits of the originally transmitted CBs using successive decoding techniques as described above. Assuming the receiver node 604 is unsuccessful in its decoding attempt, optionally feedback 620 may be transmitted back to the transmitter node 602. The feedback 620 may be similar to the feedback 614 previously described.

The transmitter node 602 may then transmit another set of optional control information 622 and a third transmission 624 containing another set of CCBs with a third selected code rate R₃ (selected as previously described). The receiver node 604 performs another decoding attempt and transmits optional feedback 626 as previously described. The transmissions (and optionally control information and optionally feedback) may continue to be performed until the receiver node 604 has successfully recovered all information bits of the original CBs of the first transmission and/or until a predefined maximum number of transmissions has been performed.

FIG. 6B is a signaling diagram illustrating another example of signal flow for performing a set of polar coding transmissions, using CCBs for one or more retransmissions. Compared to FIG. 6A, FIG. 6B illustrates signaling in a scenario where the transmitter node 602 is transmitted to multiple receiver nodes 604 (e.g., in a groupcast, multicast or broadcast scenario). In this example there are two receiver nodes 604-1, 604-2 (generically referred to as receiver nodes 604), although there may be more than two receiver nodes 604. In examples of DL transmission, the transmitter node 602 may be a BS 170 and the receiver node 604 may be a UE 110. The example of FIG. 6B may illustrate a set of DL transmissions, UL transmissions or SL transmissions.

The signaling in FIG. 6B is similar to that of FIG. 6A, thus some details may be omitted in the following discussion. The transmitter node 602 performs a first transmission 652, similar to the first transmission 612, at a first code rate R₁ to the multiple intended receiver nodes 604. As previously noted with respect to FIG. 6A, each receiver node 604 may, prior to the first transmission 612, receive control information to enable each receiver node 604 to receive and decode the data in the first transmission 612. Each receiver node 604 performs a decoding attempt and optionally provides respective feedback 654 to the transmitter node 602. If the feedback 654 includes information about an indicated code rate (e.g., each receiver node 604 may determine a respective index value representing a fraction of correct decoding decisions on the frozen bits, which may indicate a code rate to use for the next transmission, and may include the index value in the respective feedback), the transmitter node 602 may receive different information from each receiver node 604. For example, one receiver node 604-1 may indicate a lower code rate for the next transmission (as indicated by an index value that maps to a small fraction of correct decoding decisions) while another receiver node 604-1 may indicate a higher code rate for the next transmission (as indicated by an index value that maps to a larger fraction of correct decoding decisions).

Since the transmitter node 602 selects one code rate to use for a transmission to all intended receiver nodes 604, the transmitter node 602 may select the code rate based on the lowest indicated code rate. For example, one receiver node 604-1 includes an index value of 16 in its feedback 654 and another receiver node 604-2 includes an index value of 2 in its feedback 654. At the transmitter node 602, the index value of 16 is mapped to a fraction value of 4/16 and the index value of 2 is mapped to a fraction value of 2/4. The transmitter node 602 selects the fraction value indicating a lower amount of corrected determined frozen bits, specifically the fraction value of 4/16, and uses this to select the code rate R₂. The transmitter node 602 may include the selected code rate R₂ in the control information 656 sent to each receiver node 604.

It should be noted that the transmitter node 602 may, in other examples, select the code rate R₂ without feedback 654 from the receiver nodes 604, as previously described.

The transmitter node 602 then performs a second transmission 658 using the code rate R₂ to transmit a set of CCBs to each receiver node 604. Each receiver node 604 performs another decoding attempt and optionally provides feedback 660 to the transmitter node 602, as previously described. Additional signals (e.g., control information 662, a third transmission 664 containing another set of CCBs at a third code rate R₃ 664, optional feedback 666, etc.) may be transmitted, until a maximum number of transmissions has been performed and/or until all receiver nodes 604 have successfully recovered all the information bits of the first transmission.

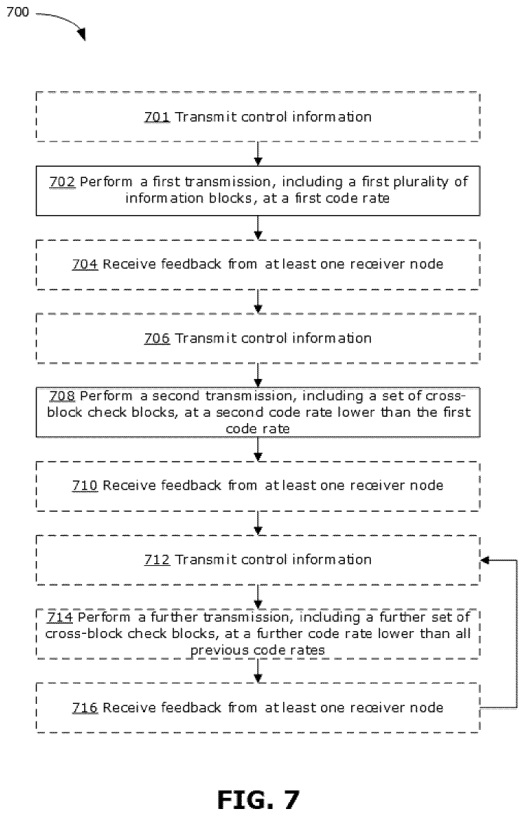

FIG. 7 is a flowchart illustrating an example method 700, which may be performed by an apparatus (e.g., a chip, a processor, a device, etc. as illustrated in FIG. 2) that is a transmitter node. For example, the method 700 may be performed by a BS 170 for DL transmissions, or may be performed by a UE 110 for UL or SL transmissions. The method 700 may be performed for unicast, multicast, groupcast or broadcast transmissions. The method 700 may be used to perform a set of transmissions (e.g., an initial transmission and one or more retransmissions) in a retransmission scheme for transmitting a plurality of polar coded CBs.

Optionally, at 701, the transmitter node may transmit control information (e.g., in a DCI signal, UCI signal or SCI signal) to the one or more receiver nodes. The control information may include, for example, information about the resource block on which each receiver node may receive data as well as information (e.g., modulation and coding scheme, redundancy version, etc.) to enable each receiver node to decode the received data.

At 702, the transmitter node performs a first transmission at a first code rate to one or more receiver nodes. The first transmission includes data, in the form of a first plurality of information blocks (i.e., CBs of the first transmission). Each information block contains a plurality of information bits. The information bits may be encoded by a polar encoder of the transmitter node, for example, and placed in bit channels of varying reliability. The first transmission also includes frozen bits (which are not part of the information blocks), which are transmitted in the least reliable bit channels.

Performing the transmission may comprise, or instead involve, transmitting or outputting the transmission. Transmitting or outputting the transmission may involve, for example, transmitting or outputting the transmission from a first processor, module, or hardware element in an apparatus, to a second, downstream processor, module, or hardware element in the apparatus, to be ultimately transmitted to another apparatus. Transmitting or outputting the transmission may also involve, for example, sending the transmission from a first apparatus (such as a transmitter node) to a second apparatus (such as a receiver node).

Optionally, at 704, the transmitter node may receive feedback from at least one receiver node. The feedback may include an indicator that decoding was successful (e.g., ACK) or unsuccessful (e.g., NACK). The feedback may additionally or alternatively include an indicator of the code rate to be used for the next transmission, which may be indirectly represented as the amount of correctly determined frozen bits at the receiver node. For example, the feedback may include an index value that maps to an approximate fraction of the correct decoding decisions on the frozen bits at the decoder of the receiver node.

The transmitter node may use information included in the feedback from the at least one receiver node to determine whether a second transmission is required and/or to select a second code rate for the second transmission.

If no feedback is received, the absence of feedback may indicate decoding was unsuccessful at the receiver node, and the transmitter node may determine that the second transmission is required based on the absence of feedback.

If no feedback is received, the transmitter node may select the second code rate based on its own channel quality estimation and/or may use a predefined second code rate (e.g., predefined in a standard).

Optionally, at 706, the transmitter node may transmit control information (e.g., in a DCI signal, UCI signal or SCI signal) to the one or more receiver nodes. The control information may include, for example, an indication of the selected second code rate and/or information about how the transmitter node generates the set of CCBs that will be sent in the second transmission.

In some examples, control information may not be sent. For example, the second code rate and the technique for generating a set of CCBs may already be known to both the transmitter and receiver nodes (e.g., already defined in a standard), or may have been pre-configured.

At 708, the transmitter node performs a second transmission, at a second code rate, to the one or more receiver nodes. The second code rate is lower than the first code rate of the first transmission. The second transmission includes a set of CCBs generated using information bits selected from across a second plurality of information blocks. As discussed above, each information block in the second plurality of information blocks is a subset of the information bits of a respective one of the first plurality of information blocks (of the first transmission), where the subset is selected from the least reliable bit channels of the respective one information block. Details of how the second plurality of information blocks may be formed by selecting information bits of the first plurality of information blocks and how the set of CCBs may be generated by combining the second plurality of information blocks have been discussed above, and need not be repeated here.

Performing the transmission may comprise, or instead involve, transmitting or outputting the transmission. Transmitting or outputting the transmission may involve, for example, transmitting or outputting the transmission from a first processor, module, or hardware element in an apparatus, to a second, downstream processor, module, or hardware element in the apparatus, to be ultimately transmitted to another apparatus. Transmitting or outputting the transmission may also involve, for example, sending the transmission from a first apparatus (such as a transmitter node) to a second apparatus (such as a receiver node).

If, after the second transmission, the maximum predefined number of transmissions has been performed, the method 700 may end.

Optionally, at 710, the transmitter node may receive further feedback from at least one receiver node (which may or may not be the same as the at least one receiver node at step 704). The feedback received at optional step 710 may be similar to that of step 704 described previously.

If all of the one or more receiver nodes are successful in recovering the information bits of the first plurality of information blocks after the second transmission, this may be indicated in the feedback (e.g., in the form of ACK) at optional step 710. The transmitter node may determine that no further transmissions are required, and the method 700 may end.

Optionally, at 712, the transmitter node may transmit further control information to the one or more receiver nodes. The control information may include information about a further transmission, such as a further code rate and/or the technique for generating another set of CCBs.

Optionally, at 714, the transmitter node performs a further transmission, at a further code rate, to the one or more receiver nodes. The first code rate is lower than the code rates of all previous transmission in the same set of transmissions (i.e., all previous transmission related to the same first plurality of information blocks). For example, a third transmission is at a third code rate that is lower than the first code rate and the second code rate. The further transmission includes a further set of CCBs generated using information bits selected from across a further plurality of information blocks. Each information block in the further plurality of information blocks is formed by selecting, from the plurality of information blocks of each respective previous transmission, a subset of the information bits of a respective one of the plurality of information blocks, where the subset is selected from the least reliable bit channels that have not been previously selected in a previous transmission.

For example, if the further transmission is a third transmission following the first and second transmissions, each information block in the third plurality of information blocks is formed by selecting a subset of information bits (from the least reliable bit channels) of each information block in the second plurality of information blocks as well as a subset of information bits (from the next lowest reliable bit channels after the bit channels that were already selected for the second transmission) of each information block in the first plurality of information blocks. Details of how the second plurality of information blocks may be formed and how the set of CCBs may be generated have been discussed above, and need not be repeated here.

If, after the further transmission, the maximum number of transmissions has been performed, the method 700 may end.

Optionally, at 716, the transmitter node may again receive feedback from at least one receiver node (which may or may not be the same as the at least one receiver node at step 704 or step 710). The feedback received at optional step 716 may be similar to that of step 704 described previously.

Steps 712 to 716 may be repeated for additional further transmissions, for example until a maximum number of transmissions has been performed, or until all of the one or more receiver nodes have successfully recovered all the information bits of the first plurality of information blocks (i.e., the original CBs of the first transmission).

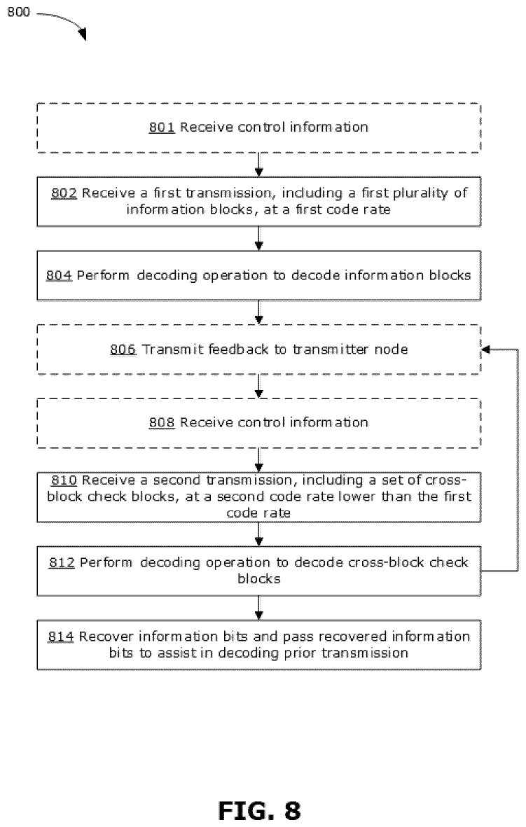

FIG. 8 is a flowchart illustrating an example method 800, which may be performed by an apparatus (e.g., as illustrated in FIG. 2) that is a receiver node. For example, the method 800 may be performed by a UE 110 receiving DL transmissions or SL transmissions, or may be performed by a BS 170 receiving UL transmissions. The method 800 may be performed in unicast, multicast, groupcast or broadcast scenarios. The method 800 may be used to receive and successfully recover the information bits of polar coded CBs over a set of transmissions in a retransmission scheme.

Optionally, at 801, the receiver node may receive control information (e.g., in a DCI signal, UCI signal or SCI signal) from a transmitter node. The control information may include, for example, information about the resource block on which the receiver node may receive data as well as information (e.g., modulation and coding scheme, redundancy version, etc.) to enable the receiver node to decode the received data.

At 802, the receiver node receives a first transmission, from a transmitter node, at a first code rate. The first transmission includes data, in the form of a first plurality of information blocks (i.e., CBs of the first transmission). Each information block contains a plurality of information bits. The information bits may be encoded by a polar encoder of the transmitter node, for example, and placed in bit channels of varying reliability. The first transmission also includes frozen bits (which are not part of the information blocks), which are transmitted in the least reliable bit channels.

At 804, the receiver node performs a decoding operation (also referred to as a decoding attempt) to decode the first plurality of information blocks. In this example, the decoding is unsuccessful, meaning that not all of the information bits of the first plurality of information blocks are correctly recovered.

Optionally, at 806, the receiver node may transmit feedback to the transmitter node. The feedback may include an indicator that decoding was unsuccessful (e.g., NACK). The feedback may additionally or alternatively include an indicator of the code rate to be used for the next transmission, which may be indirectly represented as the amount of correctly determined frozen bits at the receiver node. For example, the feedback may include an index value that maps to an approximate fraction of the correct decoding decisions on the frozen bits at the decoder of the receiver node.

In some examples, the receiver node may not transmit any feedback and the absence of feedback may indicate decoding was unsuccessful.

Optionally, at 808, the receiver node may receive control information (e.g., in a DCI signal, UCI signal or SCI signal) from the transmitter node. The control information may include, for example, an indication of the selected second code rate and/or information about how the transmitter node generates the set of CCBs that will be sent in the second transmission.

In some examples, control information may not be received. For example, the second code rate and the technique for generating a set of CCBs may already be known to both the transmitter and receiver nodes (e.g., already defined in a standard), or may have been pre-configured.

At 810, the receiver node receives a second transmission, at a second code rate, from the transmitter node. The second code rate is lower than the first code rate of the first transmission. The second transmission includes a set of CCBs generated using information bits selected from across a second plurality of information blocks. As discussed above, each information block in the second plurality of information blocks is a subset of the information bits of a respective one of the first plurality of information blocks (of the first transmission), where the subset is selected from the least reliable bit channels of the respective one information block.

At 812, the receiver node performs another decoding operation to decode the set of CCBs.

If the set of CCBs cannot be successfully decoded, the method 800 may return to step 806.

If the set of CCBs can be successfully decoded, the method proceeds to 814.

At 814, the information bits in the second plurality of information blocks are recovered. This means that the second code rate is within the channel capacity. The information bits of the second plurality of information blocks are passed to be used as frozen bits, to assist in decoding the first plurality of information blocks, in a successive decoder. As previously discussed, this lowers the overall effective code rate of the first transmission to be equal to the second code rate, meaning the first transmission can be successfully decoded. Thus, all the information bits of the first plurality of information blocks can be successfully recovered.

In various examples, the present disclosure describes methods and apparatuses for communications using polar coding, in which CCBs are used in a retransmission scheme, with incremental freezing. Following a first transmissions, subsequent transmission (also referred to as retransmissions) related to the same information bits are performed using cross-block check blocks instead of regular information blocks. This helps to reduce the feedback overhead, particularly in multicast, groupcast, broadcast or network coding applications.

At the decoder, successive decoding enables reduction of decoding complexity, for example compared to conventional Turbo iterative decoding schemes. Partial decoding of information blocks in a subsequent transmission may help to improve the decoding performance of the first transmission. Additionally, the information blocks of the first transmission may be recovered even if there is some deep fade or erasure of the CCBs in subsequent transmissions.

The disclosed methods and systems may be implemented with little or no additional signaling required.

The disclosed methods and systems include retransmission schemes using predefined code rates over a set of transmissions, or using code rates selected at each transmission (e.g., based on feedback from a receiver node). The present disclosure provides an example feedback mechanism, which may be used by a receiver node to provide feedback based on the decoding success of a polar decoder, and which may be used by the transmitter node to select an appropriate code rate for a next transmission. This feedback mechanism may enable the code rate to be dynamically selected (rather than being predefined) while avoiding the need to rely on channel estimation performed by the transmitted node.

Examples of the present disclosure can be applied to HARQ applications; unicast applications; multicast, groupcast, or broadcast applications; and/or network coding applications.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration information, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method at a transmitter node, the method comprising:
performing a first transmission at a first code rate, the first transmission including a first plurality of information blocks, each information block of the first plurality of information blocks having a corresponding plurality of information bits; and
performing a second transmission at a second code rate, the second code rate being lower than the first code rate, the second transmission including a set of cross-block check blocks generated using information bits selected from across a second plurality of information blocks, each of the second plurality of information blocks being a subset of the corresponding plurality of information bits of a respective information block of the first plurality of information blocks, respective information bits of each subset being selected from least reliable bit channels of the respective information block of the first plurality of information blocks.

2. The method of claim 1, wherein the second code rate is a predefined fraction of the first code rate.

3. The method of claim 1, further comprising:
prior to the performing the second transmission, receiving information indicative of a code rate for a next transmission; and
selecting the second code rate based on the received information.

4. The method of claim 1, wherein each information block of the second plurality of information blocks is sized such that a size of a remaining subset of unselected information bits of the respective information block of the first plurality of information blocks corresponds to an effective code rate equal to the second code rate.

5. The method of claim 1, wherein the set of cross-block check blocks is generated by cross-interleaving the information bits selected from across the second plurality of information blocks.

6. The method of claim 1, wherein the first transmission and the second transmission belong to a set of transmissions for transmitting the first plurality of information blocks, the method further comprising:
performing at least one further transmission in the set of transmissions, wherein the at least one further transmission is at a code rate that is lower than code rates of all prior transmissions in the set of transmissions, and wherein the at least one further transmission includes a further set of cross-block check blocks generated using information bits selected from across a further plurality of information blocks, the further plurality of information blocks being subsets of corresponding information bits of a corresponding plurality of information blocks of each prior transmission, the subsets being selected from least reliable bit channels that have not been included in previously selected subsets.

7. A method at a receiver node, the method comprising:
receiving, from a transmitter node, a first transmission at a first code rate, the first transmission including a first plurality of information blocks, each information block of the first plurality of information blocks having a corresponding plurality of information bits;
performing a decoding operation to decode the first plurality of information blocks, the decoding operation being unsuccessful;
receiving, from the transmitter node, a second transmission at a second code rate that is lower than the first code rate, the second transmission including a set of cross-block check blocks generated using information bits selected from across a second plurality of information blocks, each of the second plurality of information blocks being a subset of the corresponding plurality of information bits of a respective information block of the first plurality of information blocks, respective information bits of each subset being selected from least reliable bit channels of the respective information block of the first plurality of information blocks; and
performing another decoding operation to decode the set of cross-block check blocks, wherein the decoded set of cross-block check blocks is useable to assist in decoding the first plurality of information blocks.

8. The method of claim 7, wherein the set of cross-block check blocks is successfully decoded, the method further comprising:
recovering the second plurality of information blocks from the decoded set of cross-block check blocks; and
passing information bits of the recovered second plurality of information blocks to be used as frozen bits to assist in decoding the first plurality of information blocks.

9. The method of claim 7, further comprising:
prior to the receiving the second transmission, transmitting feedback to the transmitter node, the feedback including information indicative of an amount of frozen bits correctly determined by the receiver node for the first transmission.

10. The method of claim 7, further comprising:
prior to the receiving the second transmission, receiving control information from the transmitter node, the control information indicating the second code rate.

11. An apparatus at a transmitter node, the apparatus comprising:
at least one processor; and
a memory storing instructions which, when executed by the at least one processor, cause the apparatus to perform:
performing a first transmission at a first code rate, the first transmission including a first plurality of information blocks, each information block of the first plurality of information blocks having a corresponding plurality of information bits; and
performing a second transmission at a second code rate, the second code rate being lower than the first code rate, the second transmission including a set of cross-block check blocks generated using information bits selected from across a second plurality of information blocks, each of the second plurality of information blocks being a subset of the corresponding plurality of information bits of a respective information block of the first plurality of information blocks, respective information bits of each subset being selected from least reliable bit channels of the respective information block of the first plurality of information blocks.

12. The apparatus of claim 11, wherein the second code rate is a predefined fraction of the first code rate.

13. The apparatus of claim 11, wherein the instructions further cause the apparatus to perform:
prior to the performing the second transmission, receiving information indicative of a code rate for a next transmission; and
selecting the second code rate based on the received information.

14. The apparatus of claim 11, wherein each information block of the second plurality of information blocks is sized such that a size of a remaining subset of unselected information bits of the respective information block of the first plurality of information blocks corresponds to an effective code rate equal to the second code rate.

15. The apparatus of claim 11, wherein the set of cross-block check blocks is generated by cross-interleaving the information bits selected from across the second plurality of information blocks.

16. The apparatus of claim 11, wherein the first transmission and the second transmission belong to a set of transmissions for transmitting the first plurality of information blocks, and the instructions further cause the apparatus to perform:
performing at least one further transmission in the set of transmissions, wherein the at least one further transmission is at a code rate that is lower than code rates of all prior transmissions in the set of transmissions, and wherein the at least one further transmission includes a further set of cross-block check blocks generated using information bits selected from across a further plurality of information blocks, the further plurality of information blocks being subsets of corresponding information bits of a corresponding plurality of information blocks of each prior transmission, the subsets being selected from least reliable bit channels that have not been included in previously selected subsets.

17. An apparatus at a receiver node, the apparatus comprising:
at least one processor; and
a memory storing instructions which, when executed by the at least one processor, cause the apparatus to perform:
receiving, from a transmitter node, a first transmission at a first code rate, the first transmission including a first plurality of information blocks, each information block of the first plurality of information blocks having a corresponding plurality of information bits;
performing a decoding operation to decode the first plurality of information blocks, the decoding operation being unsuccessful;
receiving, from the transmitter node, a second transmission at a second code rate that is lower than the first code rate, the second transmission including a set of cross-block check blocks generated using information bits selected from across a second plurality of information blocks, each of the second plurality of information blocks being a subset of the corresponding plurality of information bits of a respective information block of the first plurality of information blocks, respective information bits of each subset being selected from least reliable bit channels of the respective information block of the first plurality of information blocks; and
performing another decoding operation to decode the set of cross-block check blocks, wherein the decoded set of cross-block check blocks is useable to assist in decoding the first plurality of information blocks.

18. The apparatus of claim 17, wherein the set of cross-block check blocks is successfully decoded, and the instructions further cause the apparatus to perform:
recovering the second plurality of information blocks from the decoded set of cross-block check blocks; and
passing information bits of the recovered second plurality of information blocks to be used as frozen bits to assist in decoding the first plurality of information blocks.

19. The apparatus of claim 17, wherein the instructions further cause the apparatus to perform:
prior to the receiving the second transmission, transmitting feedback to the transmitter node, the feedback including information indicative of an amount of frozen bits correctly determined by the receiver node for the first transmission.

20. The apparatus of claim 17, wherein the instructions further cause the apparatus to perform:
prior to the receiving the second transmission, receiving control information from the transmitter node, the control information indicating the second code rate.
